(19) United States
(12) Patent Application Publication
(10) Pub. No.: US 2025/0230848 A1
(43) Pub. Date: Jul. 17, 2025

(54) SPEED REDUCER, JOINT MODULE AND ROBOTIC ARM

(71) Applicant: T-MAX (HANGZHOU) TECHNOLOGY CO., LTD., Hangzhou (CN)

(72) Inventors: Huizhong YANG, Hangzhou (CN); Yilin YANG, Hangzhou (CN); Zhaobo QING, Hangzhou (CN); Qiong LIU, Hangzhou (CN)

(21) Appl. No.: 18/806,530

(22) Filed: Aug. 15, 2024

(30) Foreign Application Priority Data
Jan. 16, 2024 (CN) 202410063440.5

(51) Int. Cl. F16D 63/00; B25J 19/00; F16D 17/00; F16D 65/22; F16D 121/24; F16D 125/58; F16D 127/06

(52) U.S. Cl. CPC F16D 63/006; F16D 17/00; F16D 65/22; B25J 19/0004; F16D 2121/24; F16D 2125/582; F16D 2127/06

(57) ABSTRACT

In some aspects, a speed reducer includes a housing; an inner gear supported in the housing and having an inner gear hole; an outer gear arranged in the inner gear hole, meshing with the inner gear, and having an outer gear hole; an eccentric wheel arranged in the outer gear hole and configured to drive the outer gear to revolve around a rotation axis of the eccentric wheel; a brake block arranged on the eccentric wheel to rotate together with the eccentric wheel and movable relative to the eccentric wheel between a braking position and a release position; an elastic member coupled to the eccentric wheel and the brake block and configured to press the brake block towards the braking position; a limit disc arranged in the housing and engaged with the housing and the outer gear; and a drive member coupled to the eccentric wheel.

### CROSS-REFERENCE TO RELATED APPLICATIONS

This patent document claims priority to and benefits of Chinese Patent Application No. 202410063440.5, filed on Jan. 16, 2024. The entire content of the aforementioned patent document is incorporated by reference for all purposes.

### TECHNICAL FIELD

The present disclosure relates to the field of robotics, and more particularly to a speed reducer, a joint module, and a robotic arm.

### BACKGROUND

Speed reducers are widely used in electromechanical equipment such as cranes, drive joints of robots, and winches. Conventionally, speed reducers have problems such as complex structures, large volumes, low torque density, and low load capacity. Also, typically, an electromagnetic brake is usually mounted on a motor shaft of a drive motor, in order to avoid rotation of an output end of the drive motor or other drivers of the electromechanical equipment after the power is cut off. In addition, existing electromechanical equipment uses mechanisms such as worm gear pairs to achieve reverse braking. However, conventional braking measures have problems such as complex structures, a large number of parts, large volumes, small braking torques, large consumption of braking friction, high cost, and low braking reliability. A new mechanism and approach are needed to alleviate such problems for electromechanical equipment and improve the cost and reliability of speed reduction for such equipment.

### SUMMARY

In some aspects, a speed reducer according to embodiments of the present technology includes: a housing; an inner gear rotatably and at least partially supported in the housing, the inner gear having an inner gear hole; an outer gear at least partially arranged in the inner gear hole and meshing with the inner gear to drive the inner gear to rotate, the outer gear having an outer gear hole; an eccentric wheel rotatably and at least partially arranged in the outer gear hole, a rotation axis of the eccentric wheel being coaxial with a central axis of the inner gear, and the eccentric wheel being configured to drive the outer gear to revolve around the rotation axis of the eccentric wheel; a brake block arranged on the eccentric wheel to rotate together with the eccentric wheel, the brake block being movable relative to the eccentric wheel between a braking position where the brake block abuts against the outer gear and a release position where the brake block is separated from the outer gear; an elastic member coupled to the eccentric wheel and the brake block, and configured to press the brake block towards the braking position; a limit disc arranged in the housing, wherein the limit disc is engaged with the housing so that the limit disc and the housing are limited to relative movement in a first direction, and the limit disc is engaged with the outer gear so that the limit disc and the outer gear are limited to relative movement in a second direction, wherein the first direction, the second direction, and an axial direction of the limit disc are orthogonal to each other; and a drive member coupled to the eccentric wheel, a rotation axis of the drive member being coaxial with the rotation axis of the eccentric wheel. When the drive member rotates, the brake block moves to the release position relative to the eccentric wheel so that the drive member drives the eccentric wheel and the brake block to rotate together, and when the drive member stops rotating, the elastic member pushes the brake block to the braking position to prevent the eccentric wheel and the brake block from rotating together.

In some aspects, a speed reducer according to embodiments of the present technology includes: a housing; an inner gear rotatably and at least partially arranged in the housing, the inner gear having an inner gear hole, and a central axis of the inner gear hole being coaxial with a rotation axis of the inner gear; an outer gear having an outer gear hole, the outer gear being at least partially arranged in the inner gear hole and meshing with the inner gear to drive the inner gear to rotate, and the outer gear being translatable in a plane orthogonal to an axial direction of the outer gear and being prohibited from rotating around a central axis of the outer gear; an eccentric wheel having an eccentric wheel hole, the eccentric wheel being rotatably and at least partially arranged in the outer gear hole to drive the outer gear to revolve around a central axis of the eccentric wheel hole, wherein a rotation axis of the eccentric wheel, the central axis of the eccentric wheel hole, and the central axis of the inner gear are coaxial, and a central axis of an outer peripheral surface of the eccentric wheel is eccentric relative to the central axis of the eccentric wheel hole; a brake block arranged on the eccentric wheel to rotate together with the eccentric wheel, wherein the brake block is movable relative to the eccentric wheel between a braking position where the brake block abuts against the outer gear and a release position where the brake block is separated from the outer gear; a spring coupled to the eccentric wheel and the brake block, and configured to press the brake block towards the braking position; and a drive member coupled to the eccentric wheel, a rotation axis of the drive member being coaxial with the rotation axis of the eccentric wheel. When the drive member rotates, the brake block moves to the release position relative to the eccentric wheel so that the drive member drives the eccentric wheel and the brake block to rotate together, and when the drive member stops rotating, the spring pushes the brake block to the braking position to prevent the eccentric wheel and the brake block from rotating together.

In some aspects, a speed reducer according to embodiments of the present technology includes: a housing; an inner gear rotatably and at least partially arranged in the housing, the inner gear having an inner gear hole; an outer gear having an outer gear hole, the outer gear being at least partially arranged in the inner gear hole and meshing with the inner gear; an eccentric member rotatably arranged in the outer gear hole to drive the outer gear, a rotation axis of the eccentric member being coaxial with a central axis of the inner gear, a central axis of an outer peripheral surface of the eccentric member being eccentric relative to the rotation axis of the eccentric member, and the outer gear being revolvable around the rotation axis of the eccentric member and being prohibited from rotating around a central axis of the outer gear to drive the inner gear to rotate; a brake member arranged on the eccentric member to rotate together with the eccentric member, the brake member being movable between a braking position and a release position relative to the eccentric member, wherein in a radial direction of the eccentric member, the brake member when in the braking position is further away from the rotation axis of the eccentric member than when in the release position; or when the brake member moves from the release position towards the braking position, the brake member moves along a circumferential direction of the eccentric member and moves outwards along the radial direction of the eccentric member at the same time; or when the brake member moves from the release position towards the braking position, a motion trajectory of the brake member is a spiral or a cam contour gradually expanding radially outwards along the circumferential direction of the eccentric member; an elastic member coupled to the eccentric member and the brake block, and configured to press the brake block towards the braking position; and a rotatable drive member, a rotation axis of the drive member being coaxial with the rotation axis of the eccentric member. When the drive member rotates, the brake member moves to the release position relative to the eccentric member so that the drive member drives the eccentric member and the brake member to rotate together, and when the drive member stops rotating, the elastic member pushes the brake member to the braking position to prevent the eccentric member and the brake member from rotating together.

### BRIEF DESCRIPTION OF THE DRAWINGS

FIG. 1 is a perspective view of a speed reducer according to embodiments of the present technology.

FIG. 2 is a perspective view from another angle of a speed reducer according to embodiments of the present technology.

FIG. 3 is a sectional view of a speed reducer according to embodiments of the present technology.

FIG. 4 is a sectional view of a speed reducer according to embodiments of the present technology taken along line A-A in FIG. 3.

FIG. 5 is a sectional view of a speed reducer according to embodiments of the present technology taken along line B-B in FIG. 3.

FIG. 6 is a sectional view of a speed reducer according to embodiments of the present technology taken along line C-C in FIG. 3.

FIG. 7 is a sectional view of an inner gear of a speed reducer according to embodiments of the present technology.

FIG. 8 is a sectional view of a housing and a cover plate of a speed reducer according to embodiments of the present technology in a split state.

FIG. 9 is a perspective view of a brake block and an eccentric wheel of a speed reducer according to embodiments of the present technology.

FIG. 10 is a perspective view from another angle of a brake block and an eccentric wheel of a speed reducer according to embodiments of the present technology.

FIG. 11 is an assembly diagram of a brake block and an eccentric wheel of a speed reducer according to embodiments of the present technology.

FIG. 12 is another assembly diagram of a brake block and an eccentric wheel of a speed reducer according to embodiments of the present technology.

FIG. 13 is a perspective view of an eccentric wheel of a speed reducer according to embodiments of the present technology.

FIG. 14 is a perspective view from another angle of an eccentric wheel of a speed reducer according to embodiments of the present technology.

FIG. 15 is a plan view of an eccentric wheel of a speed reducer according to embodiments of the present technology.

FIG. 16 is a perspective view of a brake block of a speed reducer according to embodiments of the present technology.

FIG. 17 is a perspective view from another angle of a brake block of a speed reducer according to embodiments of the present technology.

FIG. 18 is a plan view of a brake block of a speed reducer according to embodiments of the present technology.

FIG. 19 is a perspective view of a joint module according to embodiments of the present technology.

FIG. 20 is a perspective view of a joint module according to embodiments of the present technology.

FIG. 21 is a sectional view of a joint module according to embodiments of the present technology.

FIG. 22 is a perspective view of a joint module according to another embodiment of the present technology.

FIG. 23 is a perspective view from another angle of a joint module according to another embodiment of the present technology.

FIG. 24 is a perspective view of a joint module according to another embodiment of the present technology.

FIG. 25 is a partial sectional view of a joint module according to another embodiment of the present technology.

FIG. 26 is a sectional view of a joint module according to another embodiment of the present technology.

FIG. 27 is a schematic view of a robotic arm according to embodiments of the present technology.

FIG. 28 is a schematic view of a robot according to embodiments of the present technology.

FIG. 29 is a schematic view of an electric device according to embodiments of the present technology.

### DETAILED DESCRIPTION

Embodiments of the present technology are described in detail below, examples of which are shown in the accompanying drawings. The following embodiments described with reference to the accompanying drawings are illustrative. It should be understood that the embodiments described are intended to explain the present technology rather than limit the present technology.

A speed reducer according to example embodiments of the present technology is described below.

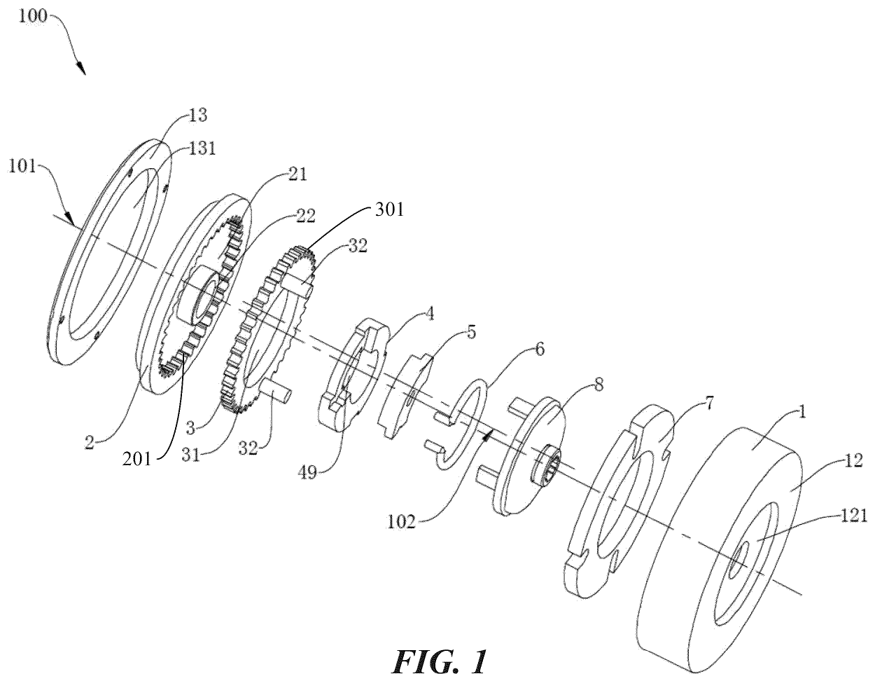

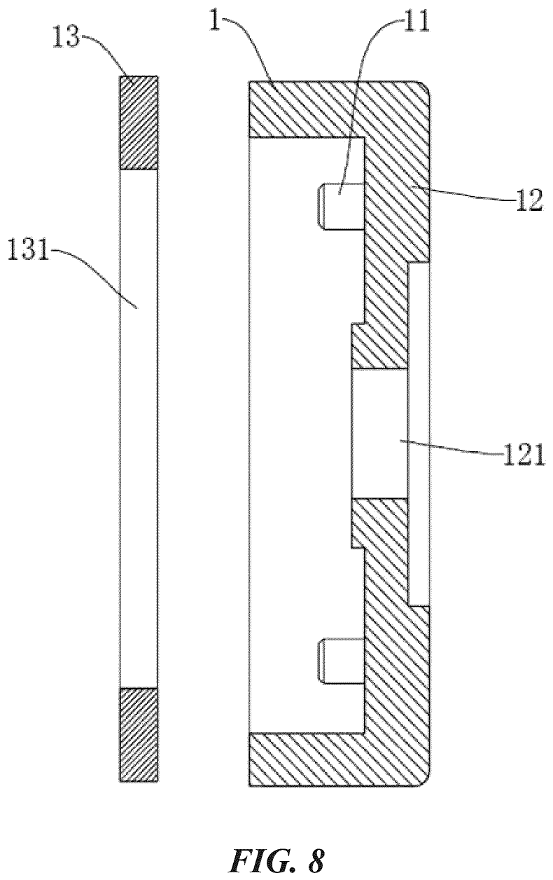

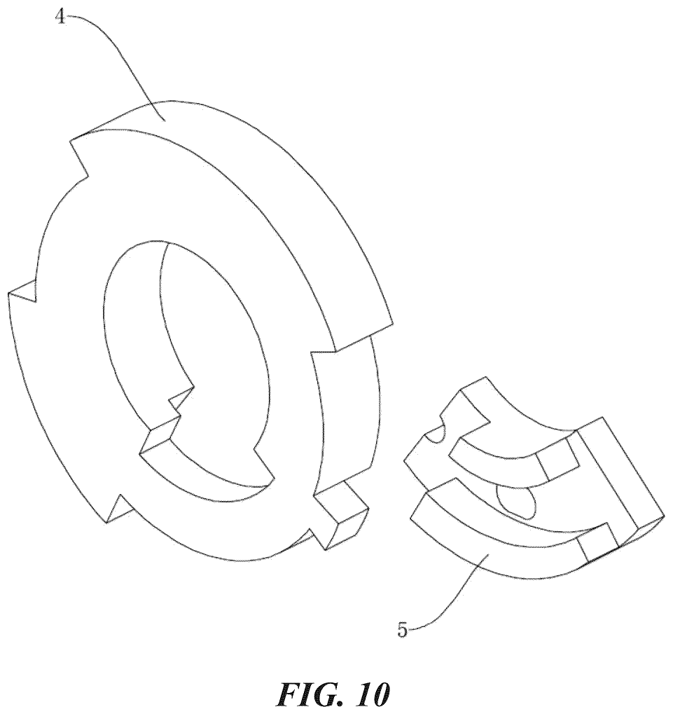

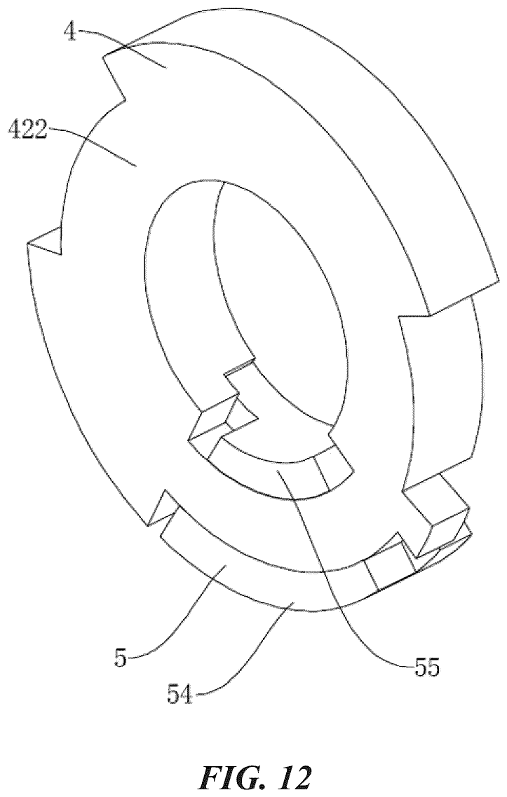

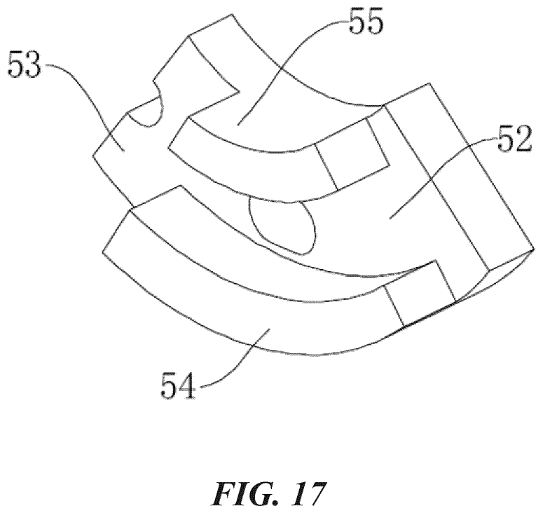

As shown in FIGS. 1 to 18, a speed reducer 100 according to some example embodiments of the present technology includes a housing 1, an inner gear 2, an outer gear 3, an eccentric wheel 4, a brake block 5, an elastic member 6, a limit disc 7, and a drive member 8.

The inner gear 2 is rotatably and at least partially supported in the housing 1. The inner gear 2 has a concentric inner gear hole 21, and the inner gear 2 can include inner teeth 201 that are arranged on a peripheral surface of the inner gear hole 21. In some embodiments, for example, the inner gear hole 21 includes a recessed portion with respect to the peripheral wall of the inner gear 2, where the inner gear hole 21 includes an aperture (hole) in a central region of the recessed portion of the inner gear hole 21. It should be understood that the concentric inner gear hole 21 can refer to a central axis of an outer peripheral surface of the inner gear 2 (which may also be called a central axis of the inner gear 2) being coaxial with a central axis of the inner gear hole 21, and a rotation axis of the inner gear 2 being coaxial with the central axis of the inner gear hole 21.

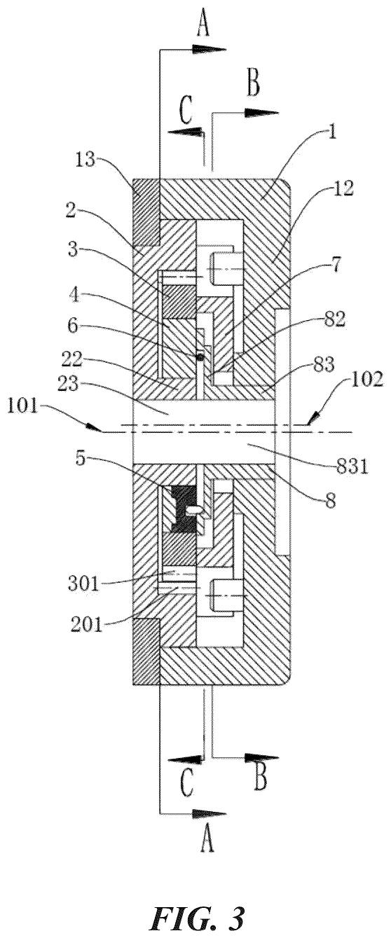

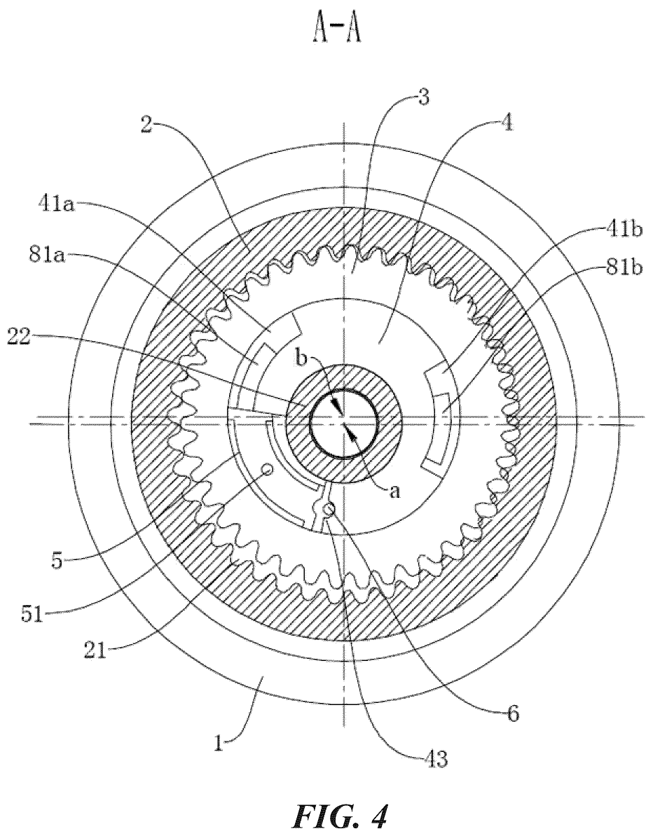

The outer gear 3 is provided and includes, on a peripheral surface, outer teeth 301. For the speed reducer 100, at least part of the outer gear 3 is arranged in the inner gear hole 21 and meshes with the inner gear 2. For example, the outer teeth 301 can mesh with inner teeth 201. The outer gear 3 has a concentric outer gear hole 31. In other words, a central axis of an outer peripheral surface of the outer gear 3 (which may also be called a central axis of the outer gear 3) is coaxial with a central axis of the outer gear hole 31. As shown in FIGS. 3 and 4, the outer gear 3 is eccentrically arranged relative to the inner gear hole 21; that is, the central axis of the outer gear 3 is parallel to but not coaxial with the central axis of the inner gear 2 (i.e., the central axis of the inner gear hole 21), and part of the outer teeth 301 of the outer gear 3 meshes with part of the inner teeth 201 of the inner gear 2.

The eccentric wheel 4 is rotatably and at least partially arranged in the outer gear hole 31. For instance, a central axis of an outer peripheral surface of the eccentric wheel 4 is coaxial with the central axis of the outer gear hole 31, the central axis of the outer peripheral surface of the eccentric wheel 4 is parallel to but not coaxial with a rotation axis of the eccentric wheel 4, and the rotation axis of the eccentric wheel 4 is coaxial with the central axis of the inner gear 2 (i.e., the central axis of the inner gear hole 21) and a central axis (a rotation axis) of the drive member 8. The eccentric wheel 4 may drive the outer gear 3 to revolve around the rotation axis of the eccentric wheel 4 (i.e., the central axis of the inner gear 2, the central axis of the inner gear hole 21), and then drive the inner gear 2 to rotate around its central axis. Herein, it should be understood that the eccentric wheel refers to the eccentricity of the outer peripheral surface of the eccentric wheel relative to the rotation axis of the eccentric wheel.

For example, the eccentric wheel 4 rotates clockwise and drives the outer gear 3 to revolve around the rotation axis of the eccentric wheel 4 in a clockwise direction, and the outer gear 3 drives the inner gear 2 to rotate clockwise by meshing with the inner gear 2. The eccentric wheel 4 rotates counterclockwise and drives the outer gear 3 to revolve around the rotation axis of the eccentric wheel 4 in a counterclockwise direction, and then the outer gear 3 drives the inner gear 2 to rotate counterclockwise.

The brake block 5 is arranged on the eccentric wheel 4 and is rotatable together with the eccentric wheel 4. For instance, the brake block 5 is movable between a braking position and a release position relative to the eccentric wheel 4. At the braking position, the brake block 5 abuts against the outer gear 3. At the release position, the brake block 5 is separated from the outer gear 3.

The elastic member 6 is coupled to the eccentric wheel 4 and the brake block 5. The elastic member 6 is configured to press the brake block 5 towards the braking position. In other words, the elastic member 6 applies elastic force to the brake block 5, and the elastic force of the elastic member 6 presses the brake block 5 towards the braking position. For example, during the movement of the brake block 5 from the braking position towards the release position, the elastic member 6 is gradually compressed, thereby the elastic member 6 applies elastic force to the brake block 5, and the elastic force presses the brake block 5 towards the braking position. It should be understood that the embodiments of the present technology are not limited to this, for example, the elastic member may also be gradually stretched.

The limit disc 7 is arranged in the housing 1 and engaged with the housing 1. Thus, the limit disc 7 and the housing 1 are limited to relative movement in a first direction. The limit disc 7 is engaged with the outer gear 3, so that the limit disc 7 and the outer gear 3 are limited to relative movement in a second direction. The first direction and the second direction are orthogonal to an axial direction of the limit disc 7, that is, a plane limited by the first direction and the second direction is orthogonal to the axial direction of the limit disc 7, and the axial direction of the limit disc 7 may be parallel to an axial direction of the inner gear 2, an axial direction of the outer gear 3, and an axial direction of the eccentric wheel 4. In other words, the limit disc 7 may only move relative to the housing 1 in the first direction, and the outer gear 3 may only move relative to the limit disc 7 in the second direction, thus the outer gear 3 is translatable relative to the housing 1 in a plane orthogonal to the axial direction of the outer gear 3, while being prohibited from rotating. Due to the meshing of the outer gear 3 and the inner gear 2, the outer gear 3 revolves around the central axis of the inner gear hole 21 under the drive of the eccentric wheel 4, while the outer gear 3 is restricted by the limit disc 7 and cannot rotate.

The drive member 8 is coupled to the eccentric wheel 4. The drive member 8 is configured to drive the eccentric wheel 4 to rotate, and a rotation axis of the drive member 8 is coaxial with the rotation axis of the eccentric wheel 4.

The speed reducer 100 according to embodiments of the present technology can automatically realize reverse braking. When the drive member rotates, first the brake block is driven to overcome an elastic force of the elastic member and move to the release position relative to the eccentric wheel to be separated from the outer gear; then the drive member drives the eccentric wheel and the brake block to rotate together, the eccentric wheel drives the outer gear to revolve in the inner gear hole around a central axis of the inner gear hole, and, in turn, the inner gear is driven to rotate, outputting a driving force or torque.

When the drive member stops rotating, the elastic member pushes the brake block from the release position to the braking position relative to the eccentric wheel, and the brake block abuts against the outer gear, thereby preventing the eccentric wheel and the brake block from rotating relative to the outer gear, that is, preventing the inner gear from rotating the eccentric wheel through a torque (load) applied to the eccentric wheel by the outer gear, so that the eccentric wheel cannot transmit the torque to the drive member and rotate the drive member. For example, when a motor of a winch stops rotating, a load applied to an eccentric wheel by a drum of the winch through inner and outer gears cannot drive the eccentric wheel to rotate, so that the inner and outer gears cannot rotate, and at the same time the eccentric wheel cannot rotate the drive member.

The speed reducer according to embodiments of the present technology may realize the automatic reverse braking function with a simple overall structure, a small number of parts, and a small volume, and has advantages of large braking torque, small consumption of braking friction, low cost, and high braking reliability.

As shown in FIGS. 1 to 3, the central axis of the inner gear 2, the central axis of the inner gear hole 21, the rotation axis of the eccentric wheel 4, and the rotation axis of the drive member 8 are coaxial, and these axes may be collectively referred to as a main axis 101. In the following description, the main axis 101 may also refer to any one of these axes. The central axis of the outer gear 3, the central axis of the outer gear hole 31, and the central axis of the outer peripheral surface of the eccentric wheel 4 are coaxial, and these axes may be collectively referred to as an eccentric axis 102. In the following description, the eccentric axis 102 may also refer to any one of these axes.

When the drive member 8 rotates, the brake block 5 may overcome the elastic force of the elastic member 6 and move the release position relative to the eccentric wheel 4, so that the drive member 8 drives the eccentric wheel 4 and the brake block 5 to rotate together. When the drive member 8 stops rotating, the elastic member 6 pushes the brake block 5 to the braking position relative to the eccentric wheel 4, and the brake block 5 abuts against the outer gear 3, thereby preventing the eccentric wheel 4 and the brake block 5 from rotating together.

In other words, when the drive member 8 rotates, the brake block 5 moves to the release position, so that the drive member 8 may simultaneously drive the eccentric wheel 4 and the brake block 5 to rotate, and the outer gear 3 is thus driven to revolve around the rotation axis of the eccentric wheel 4. When the drive member 8 stops rotating, the brake block 5 moves to the braking position under the effect of the elastic member 6, and the brake block 5 abuts against the outer gear 3. At this time, even if there is a load (torque) applied to the outer gear 3, the eccentric wheel 4 cannot rotate together with the brake block 5 relative to the outer gear 3; therefore, the inner gear 2, the outer gear 3, the eccentric wheel 4, and the brake block 5 all cannot rotate, and then the reverse braking is realized.

For example, the drive member 8 may be coupled to a drive shaft to be driven by the drive shaft to rotate in the counterclockwise direction or in the clockwise direction, the drive shaft may be a shaft of a driver or a shaft coupled to the shaft of the driver, the driver may be a motor, and the drive shaft may be a motor shaft.

For example, the drive member 8 is coupled to the motor shaft of the motor, and when the drive member 8 is driven to rotate by the motor, the brake block 5 may overcome the elastic force of the elastic member 6 and move to the release position relative to the eccentric wheel 4 to be separated from the outer gear 3. Therefore, the drive member 8 may drive the brake block 5 to rotate together with the eccentric wheel 4, and the drive member 8 then may drive the outer gear 3 to revolve in the inner gear hole 21 around the rotation axis of the eccentric wheel 4, thereby driving the inner gear 2 to rotate. The inner gear 2 may also be called an output gear of the speed reducer 100, and the inner gear 2 may be coupled to other parts to drive other parts to rotate, for example, the inner gear 2 may be coupled to a drum of a winch and a joint of a robot.

It should be understood that, in some embodiments, for example, the number of inner teeth 201 of the inner gear 2 is greater than the number of outer teeth 301 of the outer gear 3, the rotation speed of the inner gear 2 is less than the rotation speed of the eccentric wheel 4, and/or the output rotation speed of the speed reducer 100 is less than the input rotation speed of the speed reducer 100, e.g., thus the deceleration is realized.

When the motor stops rotating, the drive member 8 no longer rotates, the brake block 5 moves to the braking position relative to the eccentric wheel 4 under the elastic force of the elastic member 6 and abuts against the outer gear 3, and the friction between the brake block 5 and the outer gear 3 prevents the eccentric wheel 4 and the outer gear 3 from rotating, which then prevents the inner gear 2 from rotating.

The speed reducer 100, according to example embodiments of the present technology, can automatically realize reverse braking. When the drive member rotates, for example, first the brake block is driven to overcome an elastic force of the elastic member and move to the release position relative to the eccentric wheel to be separated from the outer gear; then the drive member drives the eccentric wheel and the brake block to rotate together, the eccentric wheel drives the outer gear to revolve in the inner gear hole around a central axis of the inner gear hole, and at the same time, the outer gear cannot rotate itself. In turn, the inner gear is driven to rotate, and the inner gear serves as the output gear to output torque.

When the drive member stops rotating, for example, the elastic member pushes the brake block from the release position to the braking position relative to the eccentric wheel, and the brake block abuts against the outer gear, thereby preventing the eccentric wheel and the brake block from rotating relative to the outer gear, that is, preventing the torque (load) on the inner gear from being transmitted to the outer gear and then transmitted to the eccentric wheel to make the eccentric wheel rotate, so that the eccentric wheel cannot transmit the torque to the drive member to make the drive member rotate. For example, when a motor of a winch stops rotating, a drum of the winch cannot drive an eccentric wheel to rotate since a torque applied to an inner gear by a weight cannot be applied to the eccentric wheel through an outer gear. That is, the inner gear and the outer gear cannot rotate, and at the same time, the eccentric wheel cannot make the drive member rotate.

It should be understood that, in the embodiments of the present technology, for example, “reverse” in “reverse braking” refers to a direction in which the torque applied to the inner gear is transmitted towards the drive member, and correspondingly, “forward” refers to a direction in which the torque of the drive member is transmitted towards the inner gear.

The speed reducer 100 according to embodiments of the present technology may realize the automatic reverse braking function with a simple overall structure, a small number of parts, and a small volume, and has the advantages of large torque density, large braking torque, small consumption of braking friction, low cost, and high braking reliability.

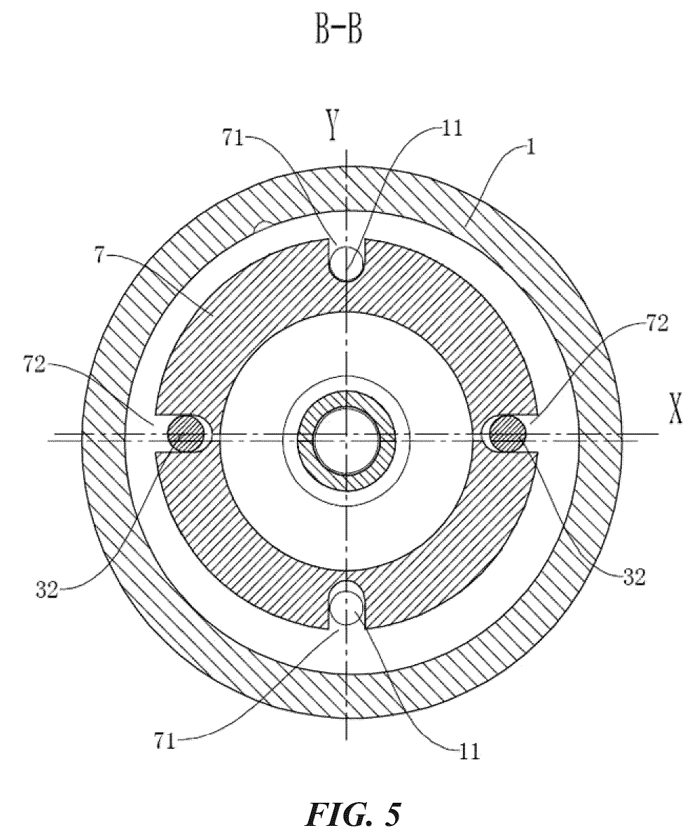

In some embodiments, for example, one of the limit disc 7 and the housing 1 is provided with a first limit portion 11, and the other one of the limit disc 7 and the housing 1 is provided with a first limit groove 71. One example is illustrated in FIG. 5, which shows a sectional view of the speed reducer 100, according to some example embodiments of the present technology, taken along line B-B in FIG. 3. The first limit portion 11 is fitted in the first limit groove 71 and is movable along the first direction, thus limiting the limit disc 7 to move only in the first direction relative to the housing 1. One of the limit disc 7 and the outer gear 3 is provided with a second limit portion 32, and the other one of the limit disc 7 and the outer gear 3 is provided with a second limit groove 72. The second limit portion 32 is fitted in the second limit groove 72 and is movable along the second direction, thus limiting the outer gear 3 to move only in the second direction relative to the limit disc 7.

In some examples, as shown in FIGS. 1 to 8, the first limit portion 11 is arranged on an end wall 12 of the housing 1 and extends from the end wall 12 of the housing 1 along an axial direction of the housing 1 (i.e., the axial direction of the limit disc 7, or the main axis 101) towards the limit disc 7. The second limit portion 32 is arranged on the outer gear 3 and extends from the outer gear 3 along the main axis 101 towards the limit disc 7. The first limit portion 11 and the second limit portion 32 each may be a cylindrical rod.

The first limit groove 71 and the second limit groove 72 are in an outer peripheral surface of the limit disc 7 and may penetrate the limit disc 7 along the axial direction of the limit disc 7. The first limit portion 11 extends into and fits in the first limit groove 71 along the axial direction of the limit disc 7, and the second limit portion 32 extends into and fits in the second limit groove 72 along the axial direction of the limit disc 7. The first limit groove 71 and the second limit groove 72 each may be U-shaped. The first limit groove 71 extends along the first direction (a direction where a Y axis is located in FIG. 5, i.e., an up-down direction), and the first limit portion 11 is slidable in the first limit groove 71 along the first direction; the second limit groove 72 extends along the second direction (a direction where an X axis is located in FIG. 5, i.e., a left-right direction), and the second limit portion 32 is slidable in the second limit groove 72 along the second direction.

In other examples, the limit disc 7 has a first side surface and a second side surface opposite each other in the axial direction of the limit disc 7, the first limit groove 71 is in the first side surface of the limit disc 7 and is recessed by a predetermined depth towards the second side surface, and the second limit groove 72 is in the second side surface of the limit disc 7 and is recessed by a predetermined depth towards the first side surface.

In some specific examples, as shown in FIGS. 1, 2, and 8, there are two first limit portions 11, two second limit portions 32, two first limit grooves 71, and two second limit grooves 72. The two first limit portions 11 are opposite in the first direction and the two first limit grooves 71 are opposite in the first direction, and the two first limit portions 11 fit in one-to-one correspondence in the two first limit grooves 71. The two second limit portions 32 are opposite in the second direction and the two second limit grooves 72 are opposite in the second direction, and the two second limit portions 32 fit in one-to-one correspondence in the two second limit grooves 72. In this way, the limiting between the limit disc 7 and the housing 1 and between the outer gear 3 and the limit disc 7 is more stable and reliable, and the limit structure is simpler.

In some embodiments, as shown in FIGS. 1 to 18, the eccentric wheel 4 is provided with a toggle slot 41, the drive member 8 is provided with a toggle block 81, and the toggle block 81 is movably fitted in the toggle slot 41. When the drive member 8 rotates in one of a clockwise direction and a counterclockwise direction, the toggle block 81 overcomes the elastic force of the elastic member 6 and pushes the brake block 5 to the release position to drive the eccentric wheel 4 and the brake block 5 to rotate together. When the drive member 8 rotates in the other one of the clockwise direction and the counterclockwise direction, the toggle block 81 drives the eccentric wheel 4 to rotate so that the brake block 5 overcomes the elastic force of the elastic member 6 and moves to the release position, so that the toggle block 81 drives the eccentric wheel 4 and the brake block 5 to rotate together.

FIG. 4 shows a sectional view of the speed reducer 100, according to some example embodiments of the present technology, taken along line A-A in FIG. 3. In some examples, as shown in FIG. 4, when the drive member 8 rotates in a counterclockwise direction, the toggle block 81 overcomes the elastic force of the elastic member 6 and pushes the brake block 5 to the release position to drive the eccentric wheel 4 and the brake block 5 to rotate together. In other words, the drive member 8 directly pushes the brake block 5 through the toggle block 81, so that the brake block 5 overcomes the elastic force of the elastic member 6 and moves to the release position relative to the eccentric wheel 4, and then the toggle block 81 directly or through the brake block 5 applies force to the eccentric wheel 4 to drive the eccentric wheel 4 and the brake block 5 to rotate together.

In other examples, as shown in FIG. 4, when the drive member 8 rotates in a clockwise direction, the toggle block 81 drives the eccentric wheel 4 to rotate, and the relative rotation occurs between the eccentric wheel 4 and the brake block 5, whereby the brake block 5 overcomes the elastic force of the elastic member 6 and moves to the release position, and then the toggle block 81 drives the eccentric wheel 4 and the brake block 5 to rotate together. In other words, the drive member 8 drives the eccentric wheel 4 to rotate through the toggle block 81, whereby the brake block 5 overcomes the elastic force of the elastic member 6 and moves to the release position, and then the toggle block 81 directly applies force to the eccentric wheel 4 to drive the eccentric wheel 4 and the brake block 5 to rotate together.

In some embodiments, as shown in FIGS. 1 to 18, the toggle slot 41 includes a first toggle slot 41a and a second toggle slot 41b, and the toggle block 81 includes a first toggle block 81a and a second toggle block 81b. The first toggle block 81a is movably fitted in the first toggle slot 41a, and the second toggle block 81b is movably fitted in the second toggle slot 41b. The brake block 5 corresponds to the first toggle slot 41a, that is, the brake block 5 may be driven by the first toggle block 81a fitted in the first toggle slot 41a. When the drive member 8 rotates in the clockwise direction or the counterclockwise direction, the first toggle block 81a is driven to move in the first toggle slot 41a around the rotation axis of the drive member 8 (the main axis), and the second toggle block 81b is driven to move in the second toggle slot 41b around the rotation axis of the drive member 8.

In some examples, when the drive member 8 rotates counterclockwise, the first toggle block 81a overcomes the elastic force of the elastic member 6 and is in direct contact with the brake block 5 to push the brake block 5 to the release position.

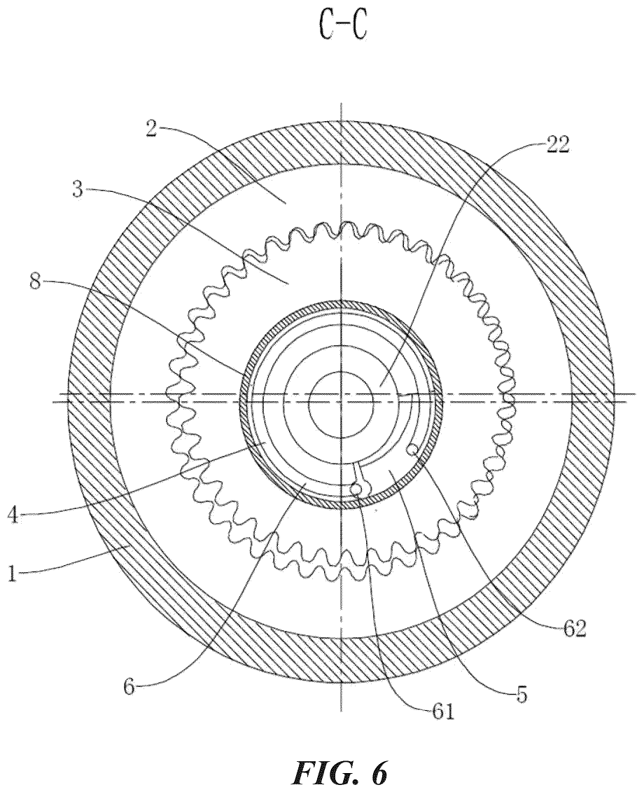

Specifically, as shown in FIGS. 4 and 6, the brake block 5 is in the braking position, and the brake block 5 abuts against the outer gear 3, that is, the brake block 5 abuts against a peripheral wall surface of the outer gear hole 31 and a minimum gap between the brake block 5 and the outer gear 3 is zero. FIG. 6 shows a sectional view of the speed reducer 100, according to some example embodiments of the present technology, taken along line C-C in FIG. 3, and FIG. 4 shows a sectional view of the speed reducer 100, according to some example embodiments of the present technology, taken along line A-A in FIG. 3. When the drive member 8 rotates in a counterclockwise direction in FIG. 4, the first toggle block 81a rotates in the first toggle slot 41a in the counterclockwise direction until it is in contact with an end face of the brake block 5 (an upper end face in FIG. 4), and then the first toggle block 81a applies thrust to the brake block 5 to overcome the elastic force of the elastic member 6 and pushes the brake block 5 to the release position. The brake block 5 is separated from the outer gear 3, that is, separated from the peripheral wall surface of the outer gear hole 31, and the minimum gap between the brake block 5 and the outer gear 3 is greater than zero. Then, the first toggle block 81a pushes the brake block 5 and the eccentric wheel 4 to rotate together in the counterclockwise direction, thereby driving the outer gear 3 to revolve counterclockwise around the rotation axis of the eccentric wheel 4 and driving the inner gear 2 to rotate counterclockwise.

When the first toggle block 81a pushes the brake block 5 from the braking position to the release position, the second toggle block 81b rotates in the counterclockwise direction in the second toggle slot 41b, and when the brake block 5 reaches the release position, the second toggle block 81b is spaced apart from an end wall surface of the second toggle slot 41b (an upper end wall surface in FIG. 4). In some embodiments, the second toggle block 81b may be in contact with the end wall surface of the second toggle slot 41b, but the second toggle block 81b may not apply force on the eccentric wheel 4, and the eccentric wheel 4 and the brake block 5 rotate together in the counterclockwise direction under the effect of the first toggle block 81a. As a result, the machining accuracy and assembly accuracy requirements for the drive member 8 and the eccentric wheel 4 are low, and the manufacturing cost is reduced.

In some embodiments, when the drive member 8 rotates clockwise, the second toggle block 81b drives the eccentric wheel 4 to rotate in the clockwise direction, and the brake block 5 overcomes the elastic force of the elastic member 6 and moves to the release position.

Specifically, when the drive member 8 rotates in a clockwise direction in FIG. 4, the second toggle block 81b rotates in the second toggle slot 41b in the clockwise direction until it is in contact with an end face of the second toggle slot 41b (a lower end face in FIG. 4), the second toggle block 81b applies thrust to the eccentric wheel 4 to push the eccentric wheel 4 to rotate in the clockwise direction, and a relative rotation occurs between the eccentric wheel 4 and the brake block 5, whereby the brake block 5 overcomes the elastic force of the elastic member 6 and moves to the release position. Subsequently, the second toggle block 81b drives the eccentric wheel 4 and the brake block 5 to rotate together in the clockwise direction, thereby driving the outer gear 3 to revolve clockwise around the rotation axis of the eccentric wheel 4 and then driving the inner gear 2 to rotate clockwise.

When the brake block 5 overcomes the elastic force of the elastic member 6 and moves from the braking position to the release position, the first toggle block 81a is spaced apart from an end wall surface of the first toggle slot 41a (an upper end wall surface in FIG. 4). In some embodiments, the first toggle block 81a may be in contact with the end wall surface of the first toggle slot 41a, but the first toggle block 81a may not apply force on the eccentric wheel 4, and the eccentric wheel 4 and the brake block 5 rotate together in the clockwise direction under the effect of the second toggle block 81b.

In some specific examples, as shown in FIGS. 1 to 18, there is one first toggle slot 41a, one second toggle slot 41b, one first toggle block 81a, one second toggle block 81b, one brake block 5, and one elastic member 6. The first toggle block 81a is fitted in the first toggle slot 41a and corresponds to the brake block 5, and the second toggle block 81b is fitted in the second toggle slot 41b and does not correspond to the brake block 5, that is, the second toggle block 81b is not in direct contact with the brake block 5.

In optional embodiments, the first toggle slot 41a, the second toggle slot 41b, the first toggle block 81a, the second toggle block 81b, the brake block 5, and the elastic member 6 each may be a plurality.

In some embodiments, as shown in FIGS. 1 and 2 and FIGS. 9 to 18, the toggle slot 41 is in the outer peripheral surface of the eccentric wheel 4 and penetrates the eccentric wheel 4 along the axial direction of the eccentric wheel 4, and the toggle block 81 of the drive member 8 extends into and fits in the toggle slot 41 along the axial direction of the eccentric wheel 4.

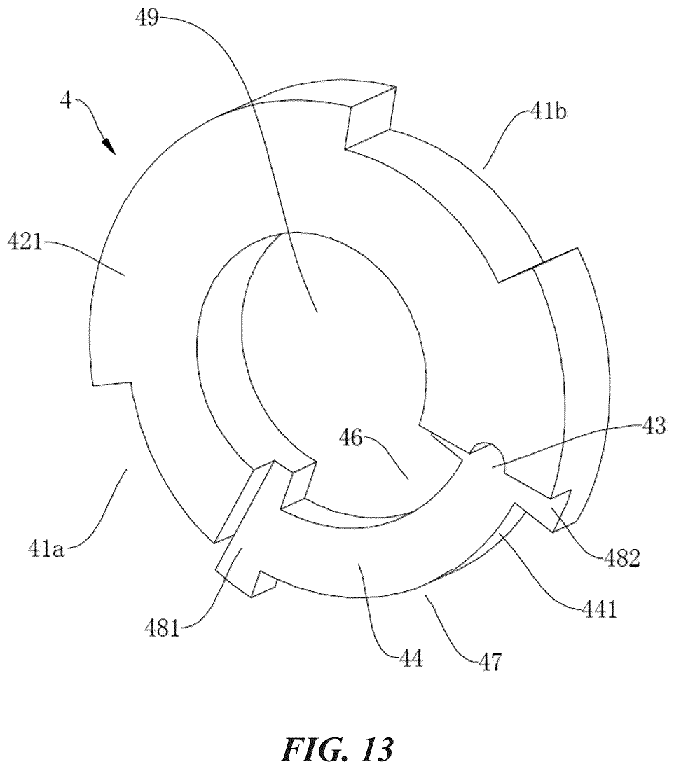

In other embodiments, the eccentric wheel 4 has opposite first end 421 (a front end facing the observer in FIG. 13) and second end 422 (a rear end away from the observer in FIG. 13) in the axial direction of the eccentric wheel 4, and the toggle slot 41 is at a junction of an end face of the first end 421 of the eccentric wheel 4 and the outer peripheral surface of the eccentric wheel 4. In other words, the toggle slot 41 is recessed by a predetermined depth from an end face of the first end 421 of the eccentric wheel 4 towards the second end 422 of the eccentric wheel 4 and an outer peripheral surface of the toggle slot 41 is open, so that the toggle slot 41 does not penetrate the eccentric wheel 4 along the axial direction of the eccentric wheel 4, and the toggle block 81 of the drive member 8 extends into and fits in the toggle slot 41 from the first end 421 of the eccentric wheel 4 along the axial direction of the eccentric wheel 4.

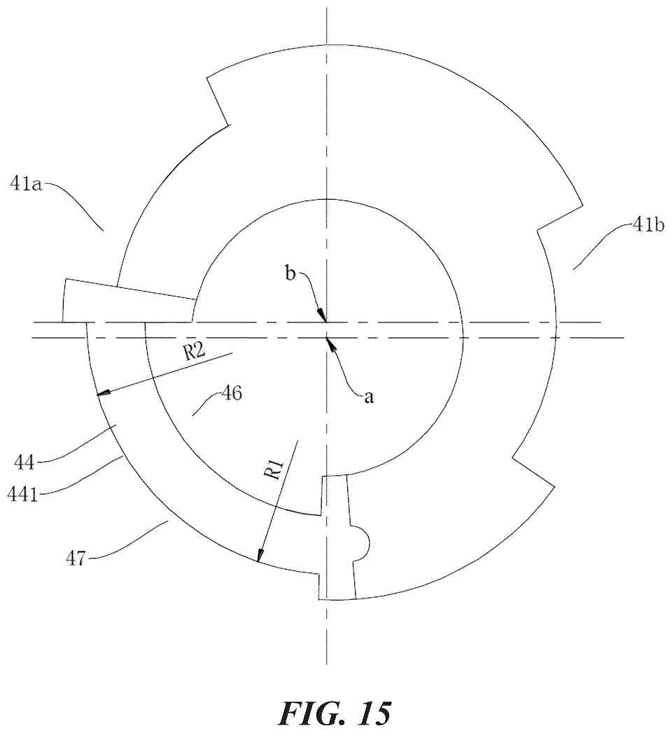

In some examples, as shown in FIG. 15, the toggle slot 41 is an arc-shaped slot extending along a circumferential direction of the outer peripheral surface of the eccentric wheel 4, specifically, an inner peripheral wall surface of the toggle slot 41 is arc-shaped, and a central axis of the inner peripheral wall surface of the toggle slot 41 is coaxial with the central axis of the outer peripheral surface of the eccentric wheel 4. In the examples shown in FIGS. 1 to 18, there are two toggle slots 41, namely, the first toggle slot 41a and the second toggle slot 41b, and the first toggle slot 41a and the second toggle slot 41b are spaced apart from each other along the circumferential direction of the eccentric wheel 4.

As shown in FIGS. 1 to 4, the toggle block 81 of the drive member 8 is configured as an arc shape matched with the toggle slot 41, and an outer peripheral surface and an inner peripheral surface of the toggle block 81 each are arc-shaped. The inner peripheral surface of the toggle block 81 may be slidably fitted in the inner peripheral wall surface of the toggle slot 41, and the inner peripheral surface of the toggle block 81 and an outer peripheral edge of the toggle slot 41 have a gap in a radial direction of the eccentric wheel 4. It should be understood that the embodiments of the present technology are not limited to this.

In some embodiments, as shown in FIGS. 1 to 3 and FIGS. 7 and 8, the housing 1 has a first end (e.g., a right end in FIG. 3) and a second end (e.g., a left end in FIG. 3) opposite to each other in an axial direction of the housing 1 (e.g., a left-right direction in FIG. 3), the first end of the housing 1 has the end wall 12, and the end wall 12 has an end wall hole 121. The second end of the housing 1 is open and is covered by a cover plate 13, and the cover plate 13 has a cover plate hole 131. One part of the inner gear 2 is located in the housing 1 and is rotatably supported by the housing 1, and the other part of the inner gear 2 is located in the cover plate hole 131 and is rotatably supported by the cover plate 13. A central axis of the end wall hole 121, a central axis of the cover plate hole 131, and the central axis of the inner gear 2 are coaxial. In other words, the housing 1 and the cover plate 13 may together form the housing of the speed reducer, and the inner gear 2 is rotatably supported in the housing. As shown in FIG. 3, an outer side surface of the inner gear 2 may be flush with an outer side surface of the cover plate 13, thus the overall appearance of the speed reducer is neat and the structure is more compact.

In some specific examples, as shown in FIGS. 1 to 3 and FIGS. 7 and 8, the outer peripheral surface of the inner gear 2 may be a step surface, so that the inner gear 2 is divided into a large diameter part 24 and a small diameter part 25 along the axial direction of the inner gear 2, and a diameter of the large diameter part 24 is greater than a diameter of the small diameter part 25. The small diameter part 25 is rotatably fitted in the cover plate hole 131, and the large diameter part 24 is rotatably fitted in the housing 1. In some embodiments, the small diameter part 25 is rotatably supported in the cover plate hole 131 by bearings, and the large diameter part 24 is rotatably supported in the housing 1 by bearings.

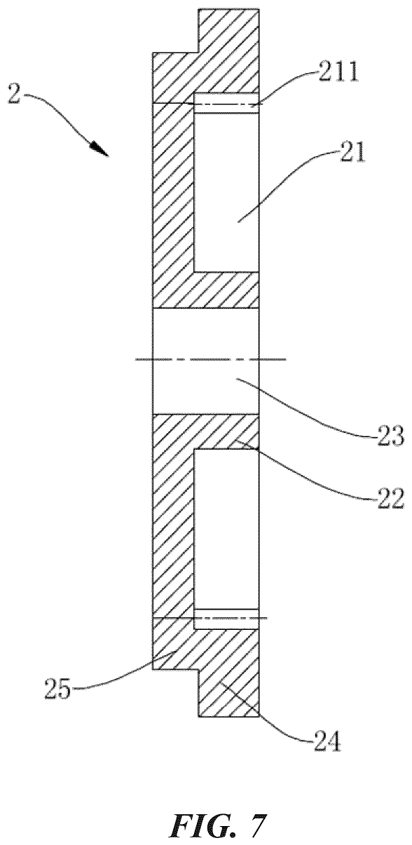

As shown in FIGS. 3 and 7, the large diameter part 24 is located at a right side of the small diameter part 25 and is coaxial with the small diameter part 25, the cover plate 13 is located at a left side of the large diameter part 24 and abuts against a left end face of the large diameter part 24 to axially limit the inner gear 2, and a left end face of the small diameter part 25 is flush with a left end face of the cover plate 13. The inner gear hole 21 is in the large diameter part 24, the outer gear 3 is located in the inner gear hole 21 and partially meshes with the inner gear 2, and a right end face of the outer gear 3 and a right end face of the eccentric wheel 4 are flush with a right end face of the large diameter part 24.

The inner gear 2 has a central flange 22 extending along the axial direction in the inner gear hole 21, and a central axis of the central flange 22 is coaxial with the central axis of the inner gear hole 21. As shown in FIG. 7, the central flange 22 is coupled to a middle part of the small diameter part 25 and extends towards the right along an axial direction of the inner gear hole 21, and a right end face of the central flange 22 is flush with the right end face of the large diameter part 24.

As shown in FIGS. 1 to 4 and FIGS. 9 to 14, the eccentric wheel 4 has an eccentric wheel hole 49, and the eccentric wheel hole 49 is coaxial with the inner gear 2, that is, a central axis of the eccentric wheel hole 49 is coaxial with the central axis of the inner gear 2. In other words, the outer peripheral surface of the eccentric wheel 4 is eccentric relative to the central axis of the eccentric wheel hole 49. As described above, the central axis of the eccentric wheel hole 49 may also be known as the main axis 101. The central flange 22 is rotatably fitted in the eccentric wheel hole 49 and is coaxial with the eccentric wheel hole 49. As shown in FIGS. 4 and 15, a center of the inner gear 2, a center of the eccentric wheel hole 49, and a center of the central flange 22 each are a center a; and a center of the outer gear 3 and a center of the outer peripheral surface of the eccentric wheel 4 each are a center b.

As shown in FIGS. 1 to 3 and FIG. 7, the central flange 22 is provided with a flange hole 23, the flange hole 23 is suitable for matching with a driven shaft, for example, the driven shaft may be a drum shaft of the drum of the winch, the flange hole 23 may penetrate the central flange 22, and a first end of the driven shaft is fitted in the flange hole 23, thus the inner gear 2 drives the driven shaft to rotate, and a second end of the driven shaft may be coupled to a driven element such as the drum of the winch to output the power to the driven element. In some embodiments, the flange hole 23 is coupled to a driven shaft spline.

In some embodiments, as shown in FIGS. 1 to 3, the drive member 8 may be configured as a drive disc, and the drive disc includes a disc body 82 and a disc hub 83 located at a center of the disc body 82. The toggle block 81 is arranged on the disc body 82 and extends from the disc body 82 along an axial direction of a drive disc towards the eccentric wheel 4, and the disc hub 83 is rotatably fitted in the end wall hole 121 of the housing 1. A central axis of the disc body 82, a central axis of the disc hub 83, a rotation axis of the disc hub 83, and the central axis of the end wall hole 121 are coaxial. As described above, the central axis of the disc body 82, the central axis of the disc hub 83, the rotation axis of the disc hub 83, and the central axis of the end wall hole 121 may also be known as the main axis 101. As shown in FIG. 3, the disc hub 83 is in clearance fit with the end wall hole 121. In some embodiments, the disc hub 83 is rotatably supported in the end wall hole 121 through bearings.

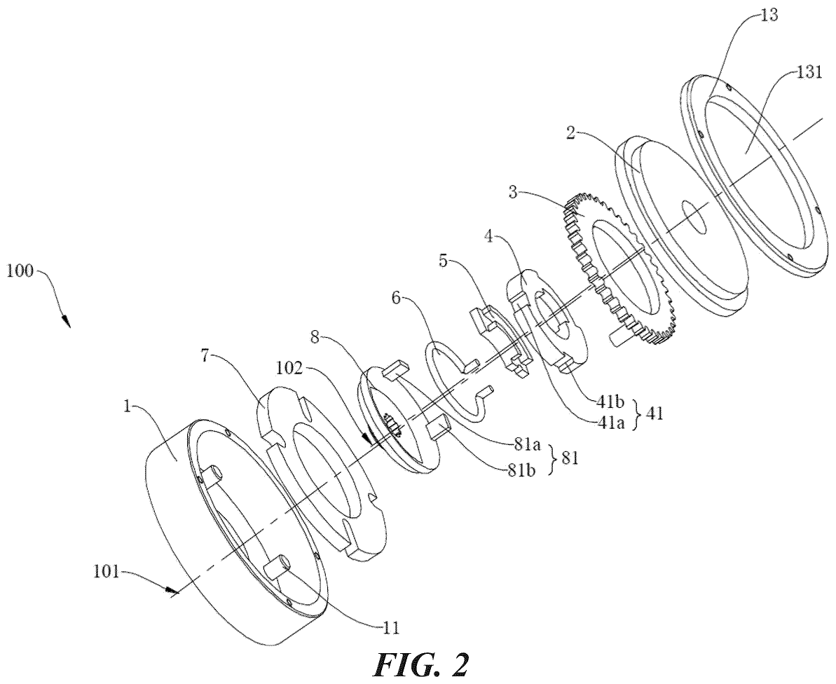

As shown in FIGS. 1 to 3, the disc hub 83 is provided with a disc hole 831, the disc hole 831 is suitable for matching with the drive shaft, such as the motor shaft of the motor, and the disc hole 831 may penetrate the disc hub 83. In some embodiments, the disc hole 831 may be a blind hole. The motor shaft is fitted in the disc hole 831 to drive the drive member 8 to rotate. In the example shown in FIG. 3, the disc hole 831 penetrates the disc hub 83 along an axial direction of the disc hub 83, and an end of the drive shaft may be fitted in the disc hole 831 to be coupled to the drive member 8. In the examples shown in FIGS. 1 and 2, a spline is arranged on an inner peripheral surface of the disc hole 831 of the drive member 8, and the drive shaft may also be provided with a spline, so that the drive member 8 is coupled to the drive shaft spline.

As shown in FIG. 3, the outer gear 3, the eccentric wheel 4, the limit disc 7, the brake block 5, the elastic member 6, and the disc body 82 of the drive member 8 each are located in the housing 1, and the disc body 82 is located between the end wall 12 of the housing 1 and the eccentric wheel 4 in an axial direction of the disc body 82. Thus, the housing 1 may better protect the above-described components, and the structure of the speed reducer 100 is more compact.

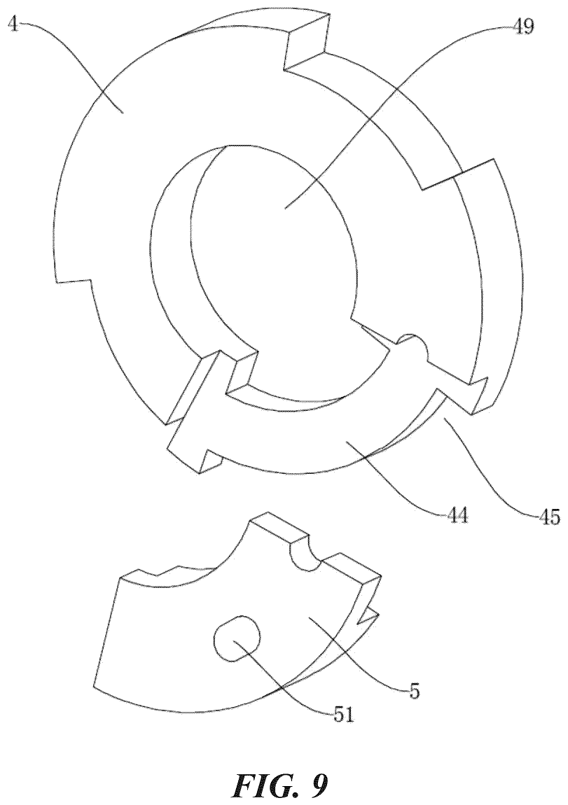

In some embodiments, as shown in FIG. 4, FIG. 6, and FIGS. 9 to 18, the end face of the first end 421 of the eccentric wheel 4 is provided with a first insertion hole 43, and the brake block 5 is provided with a second insertion hole 51. As shown in FIGS. 1 and 2, the elastic member 6 is a rod-shaped arc spring, in other words, a main body of the spring is roughly open arc-shaped, and a first end and a second end of the spring extend out a predetermined length roughly orthogonal to a plane where the main body is located, thus facilitating the connection between the brake block 5 and the eccentric wheel 4. The elastic member 6 has a first end 61 fitted in the first insertion hole 43, and the elastic member 6 has a second end 62 fitted in the second insertion hole 51. The spring exerts an elastic force to the brake block 5 to normally press the brake block 5 towards the braking position. In the process of the brake block 5 moving from the braking position towards the release position, the first end 61 and the second end 62 of the elastic member 6 are close to each other, and the spring is gradually compressed. In other optional embodiments, the spring may also be gradually stretched as the brake block 5 moves from the braking position towards the release position.

It should be understood that, for example, the elastic member 6 is not limited to the rod-shaped spring, for example, it may be an elastic piece or other forms.

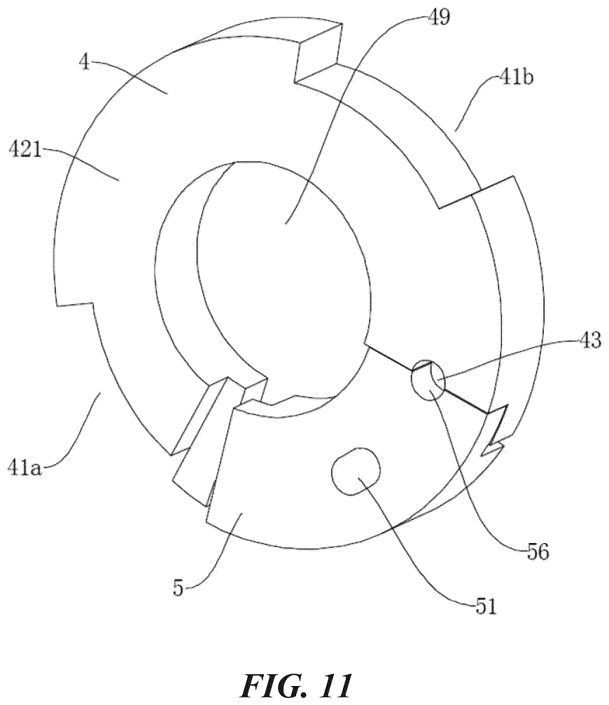

In the examples shown in FIGS. 1 to 18, the first insertion hole 43 of the eccentric wheel 4 is a first half hole, and the brake block 5 is provided with a second half hole 56. In the release position, the first half hole abuts against the second half hole 56 in the circumferential direction of the eccentric wheel 4 to form a circular hole (as shown in FIG. 11), and in the braking position, the first half hole is separated from the second half hole 56. It should be understood that a first end of the spring is always fitted in the first half hole, and the first half hole has a limiting effect on the first end of the spring.

It should be understood that, for example, the connection between the elastic member 6, the brake block 5, and the eccentric wheel 4 is not limited to the above embodiments, as long as the elastic member 6 may move the brake block 5 from the release position to the braking position when the drive member 8 stops rotating.

For example, in some example embodiments, the first insertion hole 43 of the eccentric wheel 4 is the circular hole extending from the end face of the first end 421 of the eccentric wheel 4 towards the second end 422, and the first end 61 of the elastic member 6 is fitted in the first insertion hole 43.

In some embodiments, the eccentric wheel 4 is provided with one of a guide rail and a guide groove, the brake block 5 is provided with the other one of the guide rail and the guide groove, and the guide rail is slidably fitted in the guide groove. When the brake block 5 moves between the braking position and the release position, the guide rail slides relative to the guide groove, and the sliding fit between the guide rail and the guide groove plays a guiding role in the relative movement between the eccentric wheel 4 and the brake block 5, that is, guiding the movement of the brake block 5 relative to the eccentric wheel 4.

In some embodiments, as shown in FIGS. 9 to 18, the guide rail is arranged on the eccentric wheel 4, the guide groove is arranged on the brake block 5, and the guide rail and the guide groove may be arc-shaped, that is, the guide rail is an arc-shaped guide rail 44, the guide groove is an arc-shaped guide groove 52 matched with the arc-shaped guide rail 44, and the arc-shaped guide rail 44 is slidably fitted in the arc-shaped guide groove 52.

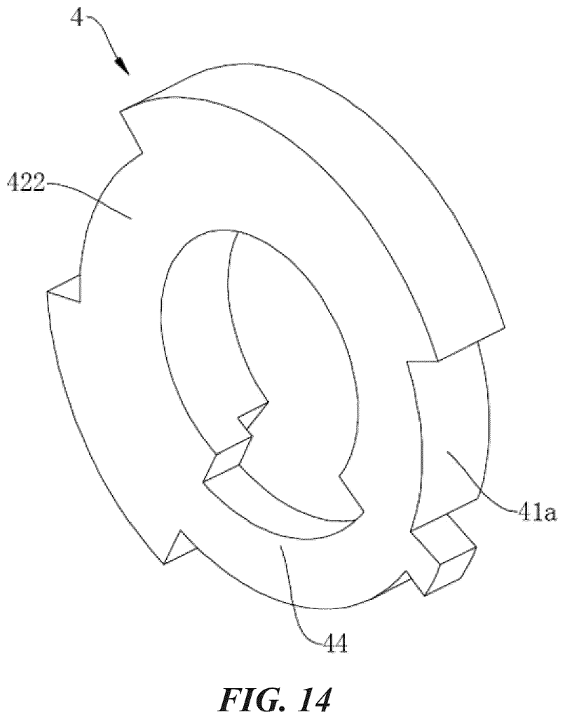

Specifically, as shown in FIGS. 9 to 18, a recess 45 is formed at a junction of the end face of the first end 421 of the eccentric wheel 4 and the outer peripheral surface of the eccentric wheel 4, that is, the recess 45 is at an edge of the end face of the first end 421 of the eccentric wheel 4. The recess 45 is recessed by a predetermined depth from the end face of the first end 421 of the eccentric wheel 4 towards the second end 422 of the eccentric wheel 4 and extends along the circumferential direction of the eccentric wheel 4. In the examples shown in FIGS. 9 to 18, the recess 45 penetrates the eccentric wheel 4 along the axial direction of the eccentric wheel 4. The arc-shaped guide rail 44 is arranged in the recess 45 and extends along the circumferential direction of the eccentric wheel 4. As shown in FIGS. 13 and 14, a surface of the arc-shaped guide rail 44 facing away from the brake block 5 is flush with a surface of the rest part of the eccentric wheel 4 facing away from the brake block 5 (an end face of the second end 422 of the eccentric wheel 4), and a surface of the arc-shaped guide rail 44 facing the brake block 5 is recessed towards the brake block 5 relative to a surface of the rest part of the eccentric wheel 4 (the end face of the first end 421 of the eccentric wheel 4).

At the braking position, part of the brake block 5 may be extended above the first toggle slot 41a to overlap with part of the first toggle slot 41a, thus facilitating the first toggle block 81a fitted in the first toggle slot 41a pushing the brake block 5 corresponding to the first toggle slot 41a. Specifically, the recess 45 is adjacent to the first toggle slot 41a in the circumferential direction of the eccentric wheel 4, and the recess 45 is communicated with the first toggle slot 41a, so that the first toggle block 81a may be in contact with the brake block 5 and push the brake block 5. In some embodiments, the recess 45 may not be communicated with the first toggle slot 41a.

As shown in FIGS. 9 to 18, the recess 45 is in connection with the first toggle slot 41a, to facilitate the first toggle block 81a fitted in the first toggle slot 41a being in contact with and pushing the brake block 5.

In some embodiments, the recess 45 may be in connection with the first toggle slot 41a, and in the braking position, part of the brake block 5 overlaps with part of the first toggle slot 41a.

As shown in FIGS. 9 to 12 and FIGS. 16 to 18, the brake block 5 includes a plate body 53, an outer boss 54, and an inner boss 55. The plate body 53 may be arc-shaped and has an arc-shaped outer peripheral surface and an arc-shaped inner peripheral surface. The plate body 53 has two plate surfaces parallel to each other in its thickness direction, for example, when the brake block 5 is mounted on the eccentric wheel 4, the plate body 53 has a first plate surface facing the eccentric wheel 4 and a second plate surface facing away from the eccentric wheel 4, and the outer boss 54 and the inner boss 55 each are arranged on the first plate surface and extend along a circumferential direction of the plate body 53. The outer boss 54 and the inner boss 55 are spaced apart from each other in a radial direction of the plate body 53, the arc-shaped guide groove 52 is formed between the outer boss 54 and the inner boss 55, an outer peripheral surface of the outer boss 54 is flush with the outer peripheral surface of the plate body 53, and an inner peripheral surface of the inner boss 55 is flush with the inner peripheral surface of the plate body 53.

As shown in FIGS. 9 to 12, the plate body 53 of the brake block 5 is fitted in the recess 45, the first plate surface of the plate body 53 abuts against the surface of the arc-shaped guide rail 44 facing the brake block 5, and the second plate surface of the plate body 53 is flush with the end face of the first end 421 of the eccentric wheel 4, in other words, the brake block 5 and the recess 45 are roughly complementary. In the radial direction of the eccentric wheel 4, the arc-shaped guide rail 44 is located between the outer boss 54 and the inner boss 55, and is slidable relative to the outer boss 54 and the inner boss 55 in the circumferential direction of the eccentric wheel 4. In other words, the arc-shaped guide rail 44 extends into the arc-shaped guide groove 52 and is slidably fitted in the arc-shaped guide groove 52. An end face of the outer boss 54 of the brake block 5 away from the plate body 53 and an end face of the inner boss 55 away from the plate body 53 are flush with the end face of the second end 422 of the eccentric wheel 4.

In the braking position, at least part of the outer peripheral surface of the outer boss 54 and at least part of the outer peripheral surface of the plate body 53 exceed the outer peripheral surface of the eccentric wheel 4 in the radial direction of the eccentric wheel 4 to abut against the outer gear 3, specifically, the brake block 5 abuts against the peripheral wall surface of the outer gear hole 31 of the outer gear 3.

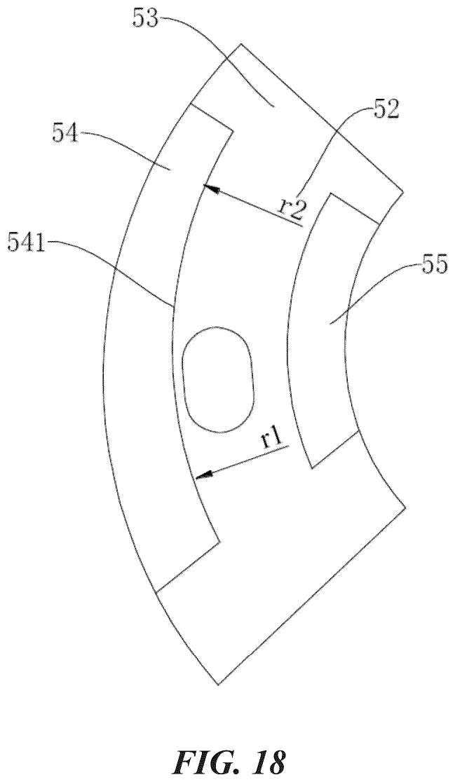

As shown in FIG. 18, the outer boss 54 has opposite first end and second end in the circumferential direction of the plate body 53, the inner boss 55 has opposite first end and second end in the circumferential direction of the plate body 53, and the plate body 53 has opposite first end and second end in its circumferential direction. The first end of the outer boss 54 and the first end of the inner boss 55 are adjacent to the first end of the plate body 53 and are spaced apart from the first end of the plate body 53 by a first distance, and the second end of the outer boss 54 and the second end of the inner boss 55 are adjacent to the second end of the plate body 53 and are spaced apart from the second end of the plate body 53 by a second distance.

As shown in FIGS. 9 to 15, an inner side of the arc-shaped guide rail 44 has an inner groove 46, and an outer side of the arc-shaped guide rail 44 has an outer groove 47. The inner boss 55 of the brake block 5 is fitted in the inner groove 46 and is slidable along the inner groove 46, and the outer boss 54 of the brake block 5 is fitted in the outer groove 47 and is slidable along the outer groove 47. It should be understood that the inner groove 46 and the outer groove 47 are both arc-shaped grooves, and an outer side and an upper surface of the outer groove 47 are open to form a semi-open groove structure, so that part of the outer boss 54 can extend outwards through the outer groove 47 to abut against the outer gear 3.

Further, the first end of the arc-shaped guide rail 44 has a first step 481, the second end of the arc-shaped guide rail 44 has a second step 482, and the arc-shaped guide rail 44 is located between the first step 481 and the second step 482 in the circumferential direction of the eccentric wheel 4 and is coupled to the first step 481 and the second step 482. An upper surface of the arc-shaped guide rail 44, an upper surface of the first step 481, and an upper surface of the second step 482 are flush; a bottom of the plate body 53 is slidably fitted to the upper surface of the arc-shaped guide rail 44, the upper surface of the first step 481, and the upper surface of the second step 482; and when the eccentric wheel 4 rotates in the counterclockwise direction, the first toggle block 81a in the first toggle slot 41a is in contact with an end face of the plate body 53.

The brake block 5 moves between the release position and the braking position along the arc-shaped guide rail 44 on the eccentric wheel 4, and is separated from or abuts against the outer gear 3. In order to more accurately limit the movement path of the brake block 5, make the reverse braking effect of the brake block 5 at the braking position more reliable, and make the release effect at the release position more reliable, in some embodiments, a curvature radius of an outer peripheral surface 441 of the arc-shaped guide rail 44 may gradually increase along a direction from the release position to the braking position. In some embodiments, the outer peripheral surface 441 of the arc-shaped guide rail 44 may be a cam surface or a spiral surface gradually expanding radially outwards along the circumferential direction of the eccentric wheel 4.

As an example, as shown in FIG. 15, the curvature radius of the outer peripheral surface 441 of the arc-shaped guide rail 44 gradually increases along the direction from the release position to the braking position, R1 and R2 respectively refer to the curvature radius of the outer peripheral surface 441 of the arc-shaped guide rail 44 at different positions, and a position referred to by R1 in the figure is closer to the release position than a position referred to by R2, in which R1 is less than R2.

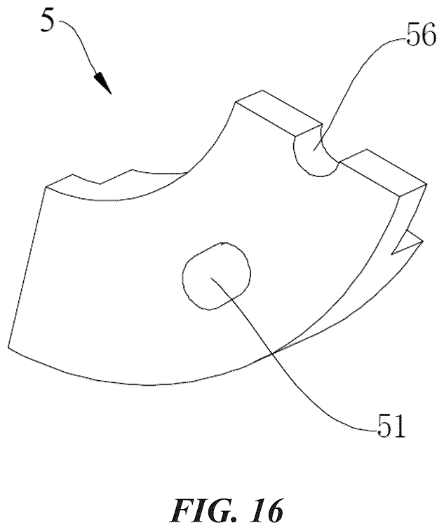

As shown in FIGS. 16 to 18, the structure of the outer boss 54 of the brake block 5 is adapted to the structure of the outer groove 47. As shown in FIG. 18, r1 and r2 refer to the curvature radius of an inner peripheral surface 541 of the outer boss 54 at different positions, in which a position referred to by r1 is closer to the release position than a position referred to by r2, and r1 is less than r2.

In some optional embodiments, for example, the speed reducer 100 includes the housing 1, the inner gear 2, the outer gear 3, the eccentric wheel 4, the brake block 5, the spring, and the drive member 8.

As described above, in some examples, the drive member 8 may be configured as the drive disc.

The inner gear 2 is rotatably and at least partially arranged in the housing 1, the inner gear 2 has the inner gear hole 21, and the central axis of the inner gear hole 21 is coaxial with the rotation axis of the inner gear 2. The outer gear 3 has the outer gear hole 31, the outer gear 3 is arranged in the inner gear hole 21 and meshes with the inner gear 2 to drive the inner gear 2 to rotate, and the outer gear 3 is translatable in the plane orthogonal to the axial direction of the outer gear 3 and is prohibited from rotating around the central axis of the outer gear 3.

The eccentric wheel 4 has the eccentric wheel hole 49, and the eccentric wheel 4 is rotatably arranged in the outer gear hole 31 to drive the outer gear 3 to revolve around the central axis of the eccentric wheel hole 49; the rotation axis of the eccentric wheel 4, the central axis of the eccentric wheel hole 49, and the central axis of the inner gear 3 are coaxial, and the central axis of the outer peripheral surface of the eccentric wheel 4 is eccentric relative to the central axis of the eccentric wheel hole 49.

The brake block 5 is arranged on the eccentric wheel 4 to rotate together with the eccentric wheel 4, and the brake block 5 is movable between a braking position and a release position relative to the eccentric wheel 4; in the braking position, the brake block 5 abuts against the outer gear 3; and in the release position, the brake block 5 is separated from the outer gear 3. The spring is coupled to the eccentric wheel 4 and the brake block 5, and is configured to press the brake block 5 towards the braking position. In other words, in the braking position, the brake block 5 prevents the eccentric wheel 4 and the brake block 5 from rotating together relative to the outer gear 3, and in the release position, the eccentric wheel 4 and the brake block 5 rotate together.

The drive member 8 is coupled to the eccentric wheel 4, the rotation axis of the drive member 8 is coaxial with the rotation axis of the eccentric wheel 4, the brake block 5 moves to the release position relative to the eccentric wheel 4 when the drive member 8 rotates, so that the drive member 8 drives the eccentric wheel 4 and the brake block 5 to rotate together, and when the drive member 8 stops rotating, the spring pushes the brake block 5 to the braking position to prevent the eccentric wheel 4 and the brake block 5 from rotating together.

The speed reducer 100 according to some example embodiments of the present technology may realize the automatic reverse braking function by the spring and the brake block with a simple overall structure, a small number of parts, and a small volume, and has the advantages of large braking torque, small consumption of braking friction, low cost, and high braking reliability.

In other optional embodiments, for example, the speed reducer includes the housing 1, the inner gear 2, the outer gear 3, an eccentric member, a brake member, the elastic member 6, and the rotatable drive member 8.

As described above, in some examples, the eccentric member may be configured as the eccentric wheel 4, the brake member may be configured as the brake block 5, and the drive member 8 may be configured as the drive disc.

The inner gear 2 is rotatably and at least partially arranged in the housing 1, and the inner gear 2 has the inner gear hole 21. The outer gear 3 has the outer gear hole 31, and the outer gear 3 is arranged in the inner gear hole 21 and meshes with the inner gear 2. The eccentric member is rotatably arranged in the outer gear hole 31 to drive the outer gear 3, a rotation axis of the eccentric member is coaxial with the central axis of the inner gear 2, a central axis of an outer peripheral surface of the eccentric member is eccentric relative to the rotation axis of the eccentric member, and the outer gear 3 is capable of revolving around the rotation axis of the eccentric member and is prohibited from rotating around the central axis of the outer gear 3 to drive the inner gear 2 to rotate.

The brake member is arranged on the eccentric member to rotate together with the eccentric member, and the brake member is movable between the braking position and the release position relative to the eccentric member. In order to realize that the brake member prevents the eccentric member from rotating in the braking position and allows the eccentric member to rotate in the release position, at least one of the following methods may be adopted: in a radial direction of the eccentric member, the brake member when in the braking position is further away from the rotation axis of the eccentric member than the brake member when in the release position; when the brake member moves from the release position towards the braking position, the brake member moves along the circumferential direction of the eccentric member and moves outwards along the radial direction of the eccentric member at the same time; and when the brake member moves from the release position towards the braking position, the motion trajectory of the brake member is a spiral or a cam contour gradually expanding radially outwards along the circumferential direction of the eccentric member. The elastic member 6 is coupled to the eccentric member and the brake block, and is configured to press the brake block towards the braking position.

The rotation axis of the drive member 8 is coaxial with the rotation axis of the eccentric member, the brake member moves to the release position relative to the eccentric member when the drive member 8 rotates, so that the drive member 8 drives the eccentric member and the brake member to rotate together, and when the drive member 8 stops rotating, the elastic member 6 pushes the brake member to the braking position to prevent the eccentric member and the brake member from rotating together.

The speed reducer according to embodiments of the present technology may realize the automatic reverse braking function with a simple overall structure, a small number of parts, and a small volume, and has the advantages of large braking torque, small consumption of braking friction, low cost, and high braking reliability.

A joint module according to example embodiments of the present technology is described below.

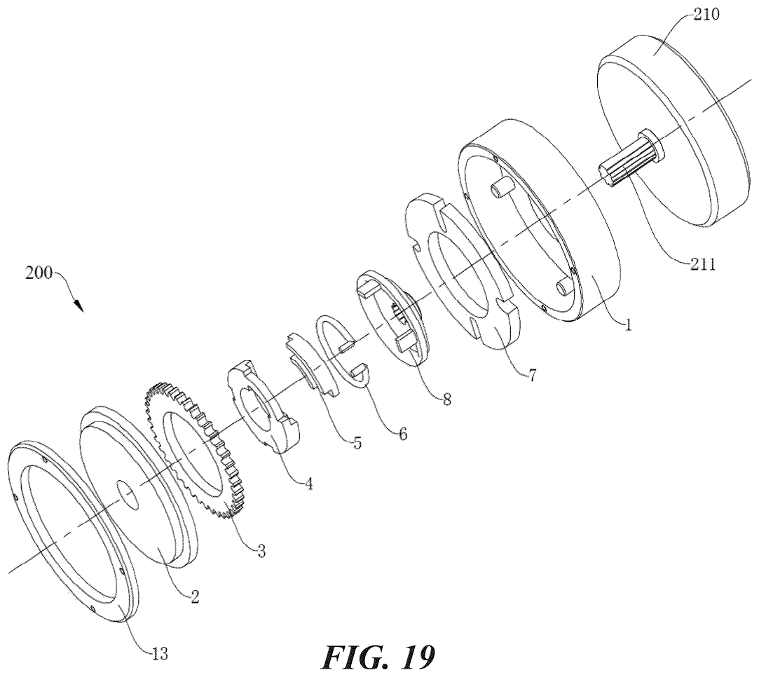

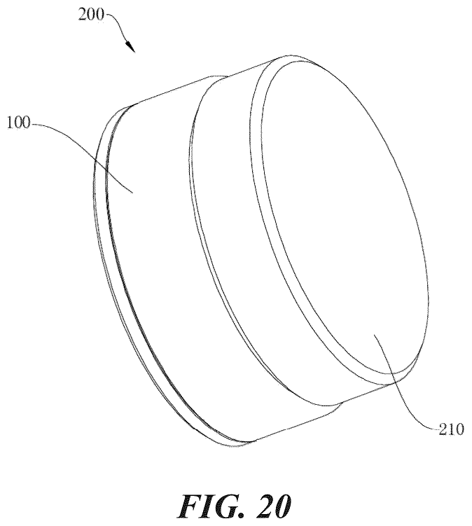

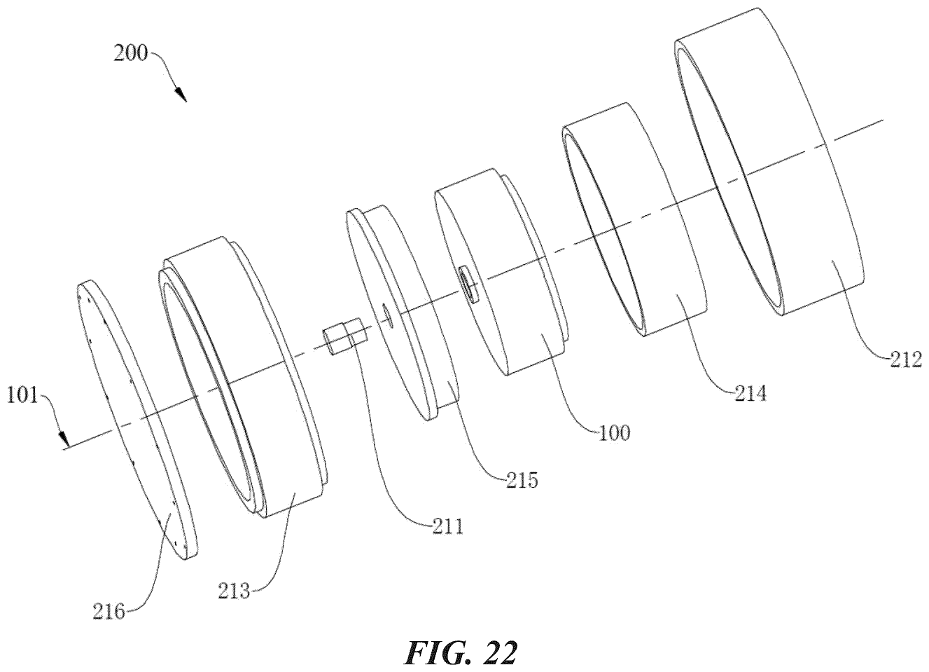

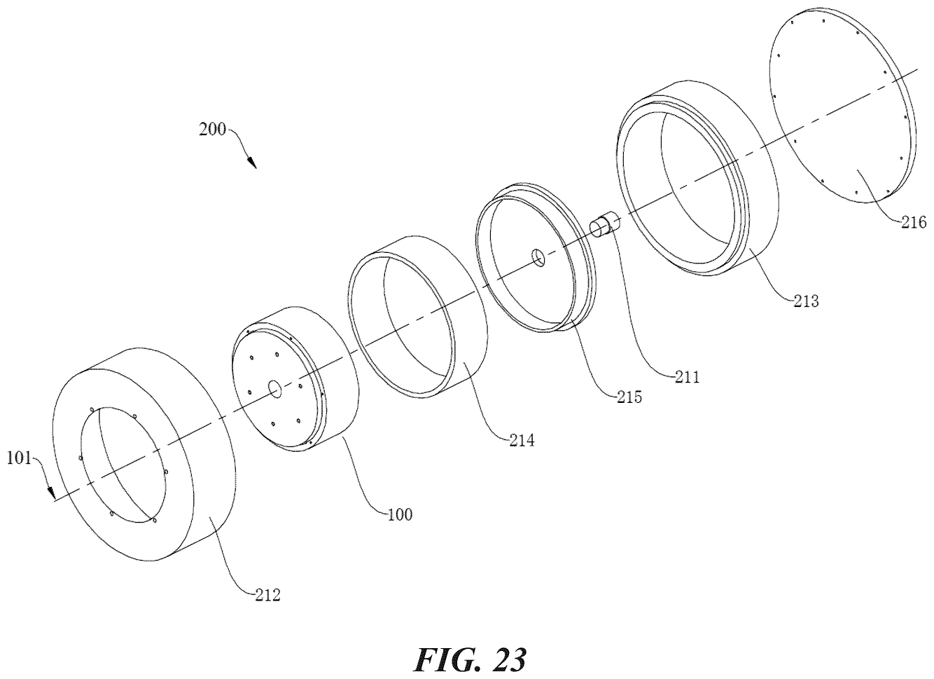

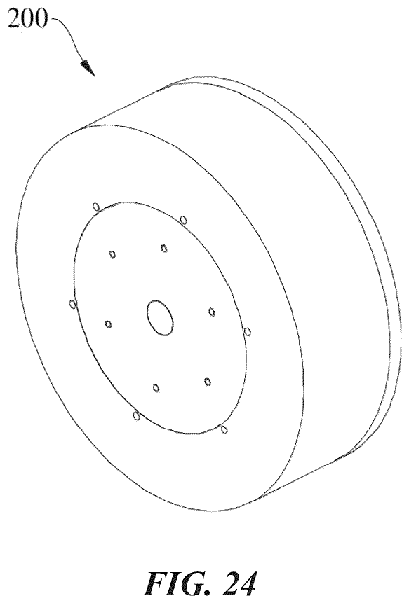

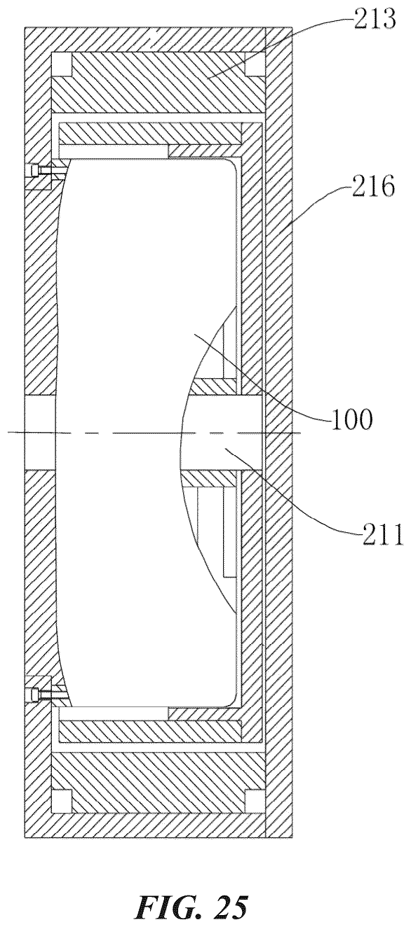

As shown in FIGS. 19 to 26, the joint module 200 according to embodiments of the present technology includes a speed reducer and a motor 210, and the speed reducer may be a speed reducer 100 according to any one of the above embodiments. A motor shaft 211 of the motor 210 is coupled to the drive member 8 of the speed reducer 100 to drive the drive member 8 to rotate in a clockwise direction or a counterclockwise direction.

The joint module according to embodiments of the present technology may automatically realize reverse braking, when the motor shaft of the motor rotates, the eccentric wheel and the brake block are driven to rotate together by the drive member, the eccentric wheel drives the outer gear to revolve in the inner gear hole around the central axis of the inner gear hole, then the inner gear is driven to rotate, and the inner gear serves as the output gear to output torque. When the motor shaft of the motor stops rotating, the elastic member pushes the brake block from the release position to the braking position relative to the eccentric wheel, and the brake block abuts against the outer gear, thereby preventing the eccentric wheel and the brake block from rotating relative to the outer gear, that is, the torque (load) on the inner gear cannot drive the eccentric wheel to rotate by the outer gear. In other words, the torque (load) cannot be reversely transmitted from the inner gear to the drive member to make the drive member and the motor shaft rotate.

In some embodiments, as shown in FIGS. 19 to 21, the motor 210 is arranged outside the housing 1 of the speed reducer 100, and the motor shaft 211 extends into the disc hole 831 of the disc hub 83 of the drive member 8 to be coupled to the disc hub 83, thereby driving the drive member 8 to rotate.

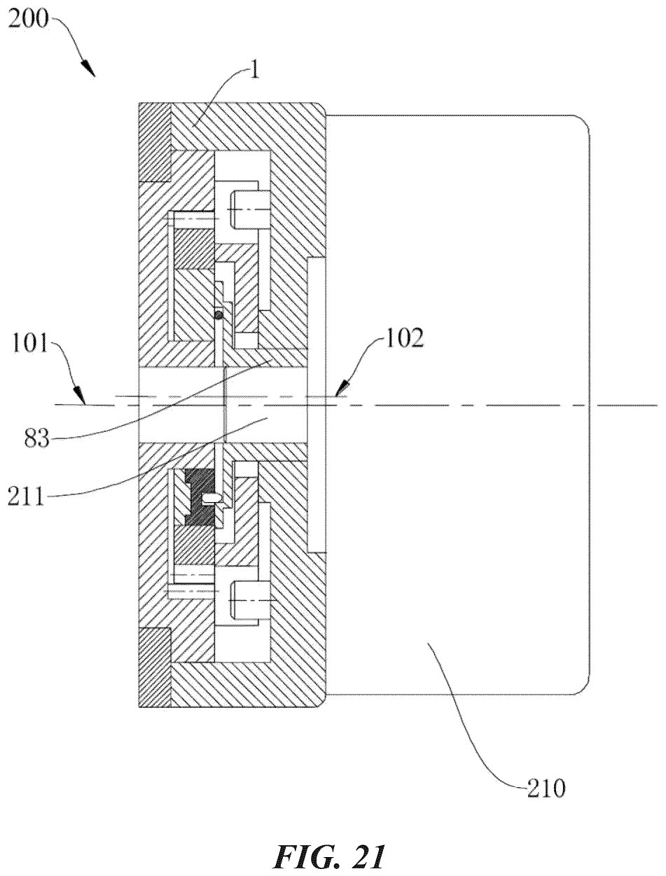

In some embodiments, as shown in FIGS. 21 to 26, the speed reducer 100 is at least partially arranged in the motor 210.

In some embodiments, as shown in FIGS. 21 to 26, the motor 210 includes the motor shaft 211, a stator seat 212, a stator 213, a rotor 214, and a rotor seat 215. The stator 213 is arranged in the stator seat 212, the rotor 214 is fitted over the rotor seat 215, and the rotor 214 and the rotor seat 215 are rotatably arranged in the stator 213. The housing 1 of the speed reducer 100 is located in the rotor 214 and may be coupled to the stator seat 212, and the motor shaft 211 of the motor 210 is coupled to the rotor seat 215 and the drive member 8. A central axis of the stator seat 212, a rotation axis of the stator 213, a rotation axis of the rotor 214, a central axis of the rotor seat 215, a central axis of the motor shaft 211, the rotation axis of the drive member 8, the rotation axis of the eccentric wheel 4, and the central axis of the inner gear 2 are coaxial. The stator 213 drives the rotor 214 to rotate, the rotor 214 drives the motor shaft 211 to rotate, and the motor shaft 211 of the motor 210 drives the drive member 8 to rotate in the clockwise direction or the counterclockwise direction.

When the motor shaft 211 of the motor 210 stops rotating, the elastic member 6 pushes the brake block 5 from the release position to the braking position relative to the eccentric wheel 4, and the brake block 5 abuts against the outer gear 3, to prevent the eccentric wheel 4 and the brake block 5 from rotating relative to the outer gear 3, that is, preventing the torque (load) applied to the inner gear 2 from being reversely transmitted to the drive member 8 to make the drive member 8 and the motor shaft 211 rotate.

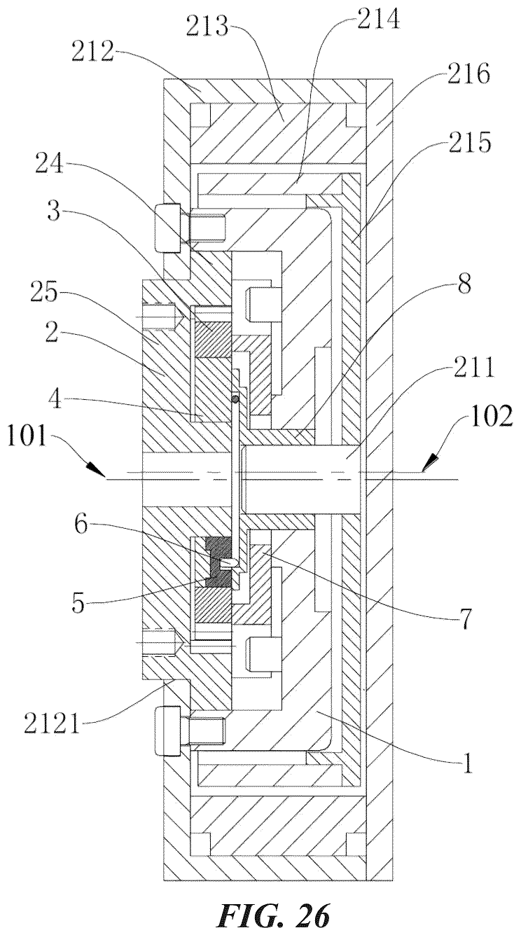

In some specific examples, as shown in FIGS. 21 to 26, the stator seat 212 has a first end (a right end in FIG. 26) and a second end (a left end in FIG. 26), the first end of the stator seat 212 is open and covered by a stator cover 216, an end wall of the second end of the stator seat 212 is provided with a through hole 2121, the inner gear 2 extends out of the stator seat 212 through the through hole 2121, and part of the inner gear 2 is rotatably supported in the through hole 2121.

In this example, as shown in FIG. 26, the speed reducer 100 does not have the cover plate 13. The small diameter part 25 of the inner gear 2 extends out of the stator seat 212 through part of the through hole 2121, and the small diameter part 25 of the inner gear 2 is rotatably supported in the through hole 2121. The end wall of the stator seat 212 abuts against an end face of the large diameter part 24 of the inner gear 2, to limit the inner gear 2, and a connecting bolt is coupled to the housing 1 of the speed reducer 100 through the end wall of the stator seat 212.

In other examples, the small diameter part 25 of the inner gear 2 may be flush with an outer surface of the end wall of the second end of the stator seat 212 (a left end face in FIG. 26). Alternatively, the inner gear 2 is integrally located inside the end wall of the second end of the stator seat 212, and the end wall of the second end of the stator seat 212 limits the inner gear 2.

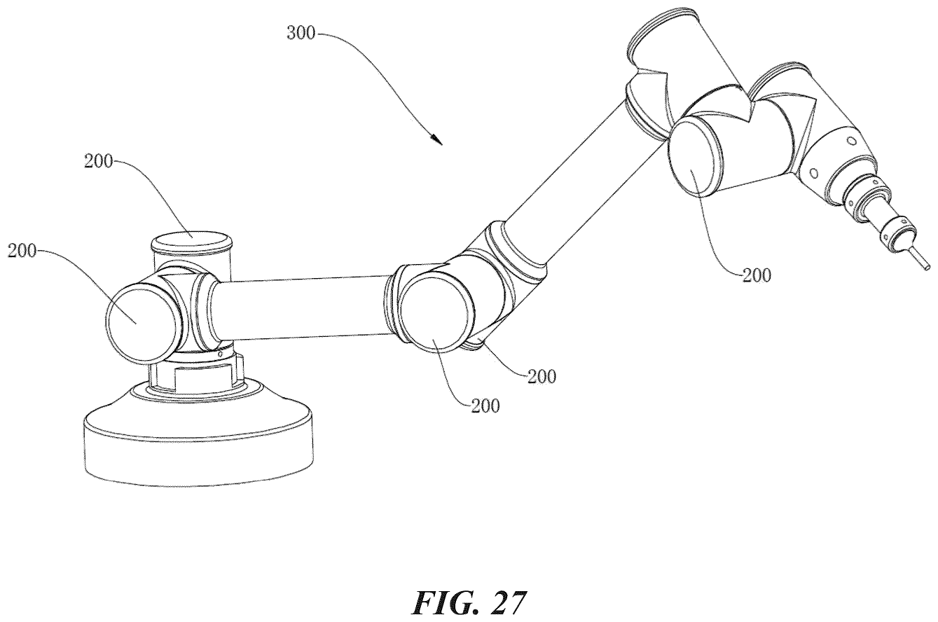

FIG. 27 shows a robotic arm 300 according to embodiments of the present technology. The robotic arm 300 includes a plurality of joint modules 200, and the robotic arm 300 may perform various actions and operations under drive of the joint modules 200.

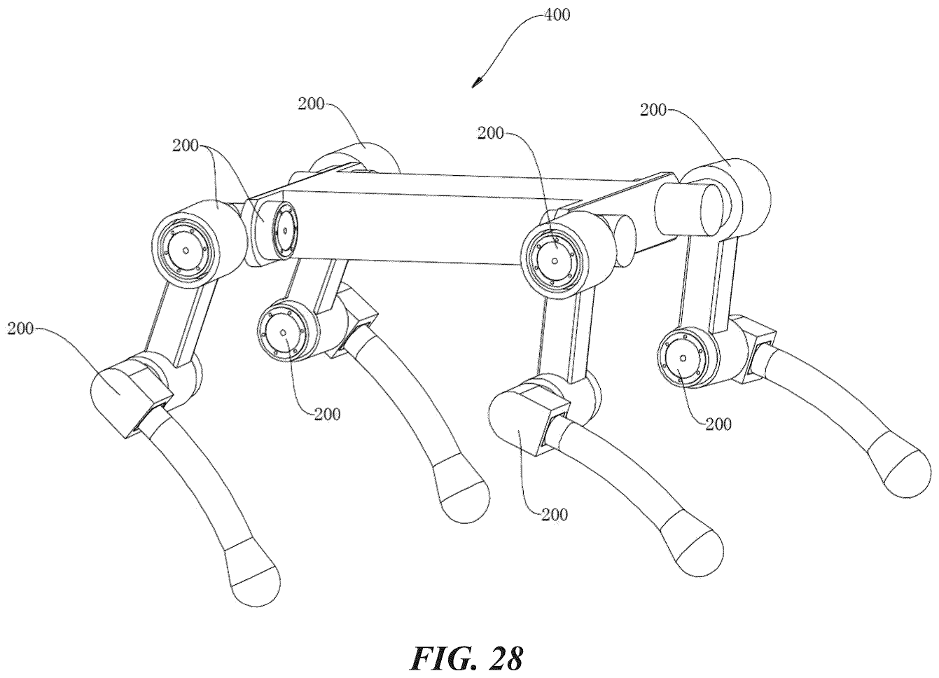

FIG. 28 shows a robot 400 according to embodiments of the present technology. The robot 400 includes a plurality of the joint modules 200, and the robot may achieve various actions under drive of the joint modules 200.

It should be understood that the robotic arm 300 and the robot 400 according to embodiments of the present technology are not limited to forms shown in the figures.

A production system according to example embodiments of the present technology may include the robotic arm 300 and/or the robot 400 according to embodiments of the present technology. For example, the production system according to embodiments of the present technology may be an automobile production line or other product production line, and the robotic arm 300 and/or the robot 400 may be configured to pick up components of the automobile and/or assemble the automobile and its components.

An electric device according to embodiments of the present technology may include the joint module 200 according to embodiments of the present technology.

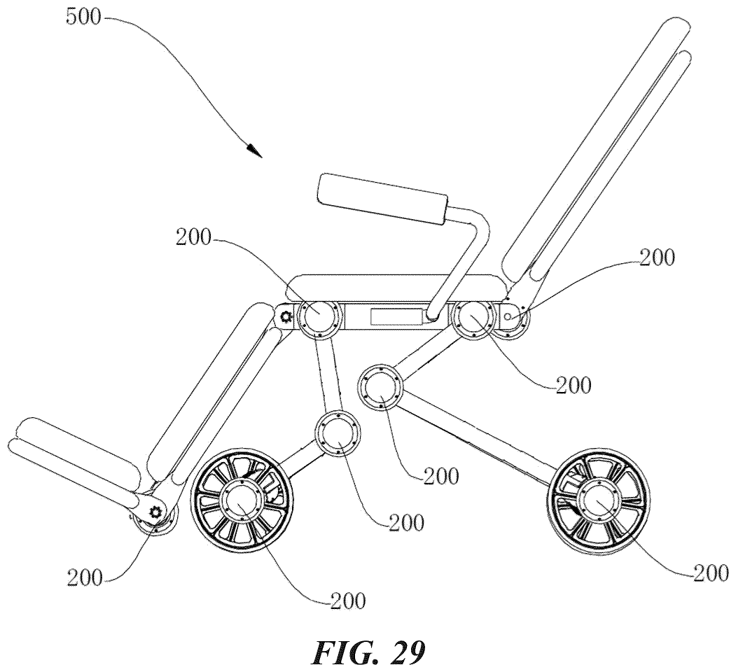

In some embodiments, the electric device may be an electric wheelchair or an electric bed. For example, as shown in FIG. 29, the electric device according to embodiments of the present technology is an electric wheelchair 500, and the electric wheelchair may walk and change its form under drive of the joint module 200.

It should be understood that the electric device according to embodiments of the present technology is not limited to the electric bed and the electric wheelchair.

### EXAMPLES

In some embodiments in accordance with the present technology (example 1), a speed reducer includes a housing; an inner gear rotatably coupled with and at least partially supported in the housing, the inner gear having an inner gear hole; an outer gear at least partially arranged in the inner gear hole and interfaced with the inner gear to drive the inner gear to rotate, the outer gear having an outer gear hole; an eccentric wheel rotatably and at least partially arranged in the outer gear hole, wherein the eccentric wheel has a rotation axis that is coaxial with a central axis of the inner gear, and wherein the eccentric wheel is configured to drive the outer gear to revolve around the rotation axis of the eccentric wheel; a brake block arranged on the eccentric wheel to rotate together with the eccentric wheel, the brake block being movable relative to the eccentric wheel between a braking position where the brake block abuts against the outer gear and a release position where the brake block is separated from the outer gear; an elastic member coupled to the eccentric wheel and the brake block, wherein the elastic member is configured to press the brake block towards the braking position; a limit disc arranged in the housing, wherein the limit disc is engaged with the housing so that the limit disc and the housing are limited to relative movement in a first direction, and the limit disc is engaged with the outer gear so that the limit disc and the outer gear are limited to relative movement in a second direction, wherein the first direction, the second direction, and an axial direction of the limit disc are orthogonal to each other; and a drive member coupled to the eccentric wheel, wherein the drive member has a rotation axis that is coaxial with the rotation axis of the eccentric wheel, wherein, when the drive member rotates, the brake block moves to the release position relative to the eccentric wheel so that the drive member drives the eccentric wheel and the brake block to rotate together, and when the drive member stops rotating, the elastic member pushes the brake block to the braking position to prevent the eccentric wheel and the brake block from rotating together.

Example 2 includes the speed reducer of example 1 or any of examples 1-16, wherein one of the limit disc and the housing is provided with a first limit portion, and the other one of the limit disc and the housing is provided with a first limit groove, the first limit portion being fitted in the first limit groove and being movable in the first direction; and one of the limit disc and the outer gear is provided with a second limit portion, and the other one of the limit disc and the outer gear is provided with a second limit groove, the second limit portion being fitted in the second limit groove and being movable in the second direction.

Example 3 includes the speed reducer of example 2 or any of examples 1-16, wherein the first limit portion is on the housing, the second limit portion is on the outer gear, and the first limit groove and the second limit groove are in the limit disc; and there are two first limit portions, two second limit portions, two first limit grooves, and two second limit grooves, wherein the two first limit portions are opposite in the first direction, and the two first limit grooves are opposite in the first direction, and wherein the two second limit portions are opposite in the second direction, and the two second limit grooves are opposite in the second direction.

Example 4 includes the speed reducer of example 2 or any of examples 1-16, wherein the first limit portion and the second limit portion are cylindrical rods, and the first limit groove and the second limit groove are U-shaped grooves.

Example 5 includes the speed reducer of example 1 or any of examples 1-16, wherein the eccentric wheel is provided with a toggle slot, the drive member is provided with a toggle block, and the toggle block is movably fitted in the toggle slot; and wherein, when the drive member rotates in one of a clockwise direction or a counterclockwise direction, the toggle block overcomes an elastic force of the elastic member and pushes the brake block to the release position to drive the eccentric wheel and the brake block to rotate together.

Example 6 includes the speed reducer of example 5 or any of examples 1-16, wherein, when the drive member rotates in the other one of the clockwise direction and the counterclockwise direction, the toggle block drives the eccentric wheel to rotate to make the brake block overcome the elastic force of the elastic member and move to the release position, so that the toggle block drives the eccentric wheel and the brake block to rotate together.

Example 7 includes the speed reducer of example 5 or any of examples 1-16, wherein the housing has a first end and a second end, the second end of the housing is open and is covered by a cover plate, an end wall of the first end of the housing has an end wall hole, and the cover plate has a cover plate hole; and one part of the inner gear is located in the housing and is rotatably supported by the housing, and the other part of the inner gear is located in the cover plate hole and is rotatably supported by the cover plate.

Example 8 includes the speed reducer of example 7 or any of examples 1-16, wherein the drive member is a drive disc and comprises a disc body and a disc hub located at a center of the disc body; the toggle block is arranged on the disc body; and the disc hub is rotatably fitted in the end wall hole.

Example 9 includes the speed reducer of example 7 or any of examples 1-16, wherein the inner gear has a central flange extending in the inner gear hole, the eccentric wheel has an eccentric wheel hole, the eccentric wheel is coaxial with the inner gear, and the central flange is rotatably fitted in the eccentric wheel hole.

Example 10 includes the speed reducer of example 7 or any of examples 1-16, wherein an outer peripheral surface of the inner gear is a step surface to divide the inner gear into a large diameter part and a small diameter part, the small diameter part is rotatably fitted in the cover plate hole, and the large diameter part is rotatably fitted in the housing.

Example 11 includes the speed reducer of example 1 or any of examples 1-16, wherein the eccentric wheel is provided with a first insertion hole and the brake block is provided with a second insertion hole; and the elastic member is an arc-shaped spring, and the elastic member has a first end fitted in the first insertion hole and a second end fitted in the second insertion hole.

Example 12 includes the speed reducer of example 1 or any of examples 1-16, wherein the eccentric wheel is provided with one of a guide rail and a guide groove; the brake block is provided with the other one of the guide rail and the guide groove; and the guide rail is slidably fitted in the guide groove.

Example 13 includes the speed reducer of example 12 or any of examples 1-16, wherein the guide rail is arranged on the eccentric wheel; the guide rail and the guide groove are arc-shaped; and a curvature radius of an outer peripheral surface of the guide rail gradually increases along a direction from the release position to the braking position, or the outer peripheral surface of the guide rail forms a cam surface or a spiral surface gradually expanding radially outwards along a circumferential direction of the eccentric wheel.

Example 14 includes the speed reducer of example 13 or any of examples 1-16, wherein a recess is formed at a junction of at least one end face of the eccentric wheel and an outer peripheral surface of the eccentric wheel, and the arc-shaped guide rail is arranged in the recess; a surface of the guide rail facing away from the brake block is flush with a surface of a rest part of the eccentric wheel facing away from the brake block; and a surface of the guide rail facing the brake block is recessed relative to a surface of the rest part of the eccentric wheel facing the brake block.

Example 15 includes the speed reducer of example 14 or any of examples 1-16, wherein the brake block comprises an arc-shaped plate body, an arc-shaped outer boss, and an arc-shaped inner boss; the outer boss and the inner boss are arranged on the plate body and extend along a circumferential direction of the plate body; the outer boss and the inner boss are spaced apart from each other in a radial direction of the plate body; the arc-shaped guide groove is formed between the outer boss and the inner boss; an outer peripheral surface of the outer boss is flush with an outer peripheral surface of the plate body, and an inner peripheral surface of the inner boss is flush with an inner peripheral surface of the plate body; and in the braking position, at least part of the outer peripheral surface of the outer boss and at least part of the outer peripheral surface of the plate body exceed the outer peripheral surface of the eccentric wheel in a radial direction of the eccentric wheel to abut against the outer gear; a first end of the outer boss and a first end of the inner boss are spaced apart from a first end of the plate body by a first distance, and a second end of the outer boss and a second end of the inner boss are spaced apart from a second end of the plate body by a second distance.

Example 16 includes the speed reducer of example 1 or any of examples 1-15, wherein the eccentric wheel is provided with a first toggle slot and a second toggle slot; the drive member is provided with a first toggle block and a second toggle block; the first toggle block is movably fitted in the first toggle slot, and the second toggle block is movably fitted in the second toggle slot; and the brake block corresponds to the first toggle slot; when the drive member rotates counterclockwise, the first toggle block overcomes an elastic force of the elastic member and pushes the brake block to the release position; and when the brake block moves to the release position, the second toggle block is spaced apart from or is in contact with an end wall surface of the second toggle slot.

In some embodiments in accordance with the present technology (example 17), a joint module includes the speed reducer of any of examples 1-16; and a motor, a motor shaft of the motor being coupled to a drive member of the speed reducer to drive the drive member to rotate.

In some embodiments in accordance with the present technology (example 18), a robotic arm includes the joint module according to example 17.

In some embodiments in accordance with the present technology (example 19), a speed reducer includes a housing; an inner gear rotatably coupled with and at least partially arranged in the housing, the inner gear having an inner gear hole, and a central axis of the inner gear hole being coaxial with a rotation axis of the inner gear; an outer gear having an outer gear hole, the outer gear being at least partially arranged in the inner gear hole and interfaced with the inner gear to drive the inner gear to rotate, and the outer gear being translatable in a plane orthogonal to an axial direction of the outer gear and being prohibited from rotating around a central axis of the outer gear; an eccentric wheel having an eccentric wheel hole, the eccentric wheel being rotatably and at least partially arranged in the outer gear hole to drive the outer gear to revolve around a central axis of the eccentric wheel hole, wherein a rotation axis of the eccentric wheel, the central axis of the eccentric wheel hole, and the central axis of the inner gear hole are coaxial, and a central axis of an outer peripheral surface of the eccentric wheel is eccentric relative to the central axis of the eccentric wheel hole; a brake block arranged on the eccentric wheel to rotate together with the eccentric wheel, wherein the brake block is movable relative to the eccentric wheel between a braking position where the brake block abuts against the outer gear and a release position where the brake block is separated from the outer gear; a spring coupled to the eccentric wheel and the brake block, and configured to press the brake block towards the braking position; and a drive member coupled to the eccentric wheel, a rotation axis of the drive member being coaxial with the rotation axis of the eccentric wheel, wherein, when the drive member rotates, the brake block moves to the release position relative to the eccentric wheel so that the drive member drives the eccentric wheel and the brake block to rotate together, and when the drive member stops rotating, the spring pushes the brake block to the braking position to prevent the eccentric wheel and the brake block from rotating together.

In some embodiments in accordance with the present technology (example 20), a speed reducer includes a housing; an inner gear rotatably coupled with and at least partially arranged in the housing, the inner gear having an inner gear hole; an outer gear having an outer gear hole, the outer gear being at least partially arranged in the inner gear hole and interfaced with the inner gear; an eccentric member rotatably arranged in the outer gear hole to drive the outer gear, a rotation axis of the eccentric member being coaxial with a central axis of the inner gear, a central axis of an outer peripheral surface of the eccentric member being eccentric relative to the rotation axis of the eccentric member, and the outer gear being revolvable around the rotation axis of the eccentric member and being prohibited from rotating around a central axis of the outer gear to drive the inner gear to rotate; a brake member arranged on the eccentric member to rotate together with the eccentric member, the brake member being movable between a braking position and a release position relative to the eccentric member, wherein in a radial direction of the eccentric member, the brake member when in the braking position is further away from the rotation axis of the eccentric member than when in the release position; or when the brake member moves from the release position towards the braking position, the brake member moves along a circumferential direction of the eccentric member and moves outwards along the radial direction of the eccentric member at the same time; or when the brake member moves from the release position towards the braking position, a motion trajectory of the brake member is a spiral or a cam contour gradually expanding radially outwards along the circumferential direction of the eccentric member; an elastic member coupled to the eccentric member and the brake member, and configured to press the brake member towards the braking position; and a rotatable drive member, a rotation axis of the drive member being coaxial with the rotation axis of the eccentric member, wherein, when the drive member rotates, the brake member moves to the release position relative to the eccentric member so that the drive member drives the eccentric member and the brake member to rotate together, and when the drive member stops rotating, the elastic member pushes the brake member to the braking position to prevent the eccentric member and the brake member from rotating together.

### CONCLUSION

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. For example, the drive member 8 may be interfaced with, configured as, or include a motor, and the motor can include a control unit embodying various systems, digital electronic circuitry, or in computer software, firmware, or hardware, which structurally and/or functionally interfaced with the motor of the drive member 8.

Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., FPGA (field programmable gate array) or ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

In the specification, it is to be understood that terms such as “central,” “longitudinal,” “transverse,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise,” “axial,” “radial,” and “circumferential” should be construed to refer to the orientation as then described or as shown in the drawings under discussion. These relative terms are for convenience of description and do not indicate or imply that the device or element referred to must have a particular orientation or be constructed and operated in a particular orientation. There terms shall not be construed as limitation on the present technology.

In addition, terms such as “first” and “second” are used herein for purposes of description and are not intended to indicate or imply relative importance or significance or to imply the number of indicated technical features. Thus, the feature defined with “first” and “second” may include one or more of this feature. In the description of the present disclosure, the term “a plurality of” means at least two, e.g., two or three, unless specified otherwise.

In the present disclosure, unless specified or limited otherwise, the terms “mounted,” “connected,” “coupled,” “fixed,” and the like are used broadly, and may be, for example, fixed connections, detachable connections, or integral connections; may also be mechanical or electrical connections; may also be a mutual connection; may also be direct connections or indirect connections via intervening structures; and may also be an inner connection or mutual interaction of two elements, which can be understood by those skilled in the art according to specific situations.

In the present disclosure, unless specified or limited otherwise, a structure in which a first feature is “on” or “below” a second feature may include an embodiment in which the first feature is in direct contact with the second feature, and may also include an embodiment in which the first feature and the second feature are not in direct contact with each other, but are contacted via an additional feature formed therebetween. Furthermore, a first feature “on,” “above,” or “on top of” a second feature may include an embodiment in which the first feature is right or obliquely “on,” “above,” or “on top of” the second feature, or may just mean that the first feature is at a height higher than that of the second feature; while a first feature “below,” “under,” or “on the bottom of” a second feature may include an embodiment in which the first feature is right or obliquely “below,” “under,” or “on the bottom of” the second feature, or may just mean that the first feature is at a height lower than that of the second feature.

Reference throughout this specification to “an embodiment,” “some embodiments,” “an example,” “a specific example,” or “some examples” means that a particular feature, structure, material, or characteristic described in connection with the embodiment or example is included in at least one embodiment or example of the present technology. Thus, the appearances of the phrases in various places throughout this specification are not necessarily referring to the same embodiment or example of the present technology. Furthermore, the particular features, structures, materials, or characteristics may be combined in any suitable manner in one or more embodiments or examples. Moreover, different embodiments or examples as well as features in different embodiments or examples described in this specification may be combined and united by those skilled in the art in case of no mutual contradiction.

Although some embodiments have been shown and described, it would be appreciated by those skilled in the art that the above embodiments are exemplary and cannot be construed to limit the present technology, and changes, modifications, alternatives, and variations can be made in the embodiments without departing from the scope of the present technology.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A speed reducer, comprising:
a housing;
an inner gear rotatably coupled with and at least partially supported in the housing, the inner gear having an inner gear hole;
an outer gear at least partially arranged in the inner gear hole and interfaced with the inner gear to drive the inner gear to rotate, the outer gear having an outer gear hole;
an eccentric wheel rotatably and at least partially arranged in the outer gear hole, wherein the eccentric wheel has a rotation axis that is coaxial with a central axis of the inner gear, and wherein the eccentric wheel is configured to drive the outer gear to revolve around the rotation axis of the eccentric wheel;
a brake block arranged on the eccentric wheel to rotate together with the eccentric wheel, the brake block being movable relative to the eccentric wheel between a braking position where the brake block abuts against the outer gear and a release position where the brake block is separated from the outer gear;
an elastic member coupled to the eccentric wheel and the brake block, wherein the elastic member is configured to press the brake block towards the braking position;
a limit disc arranged in the housing, wherein the limit disc is engaged with the housing so that the limit disc and the housing are limited to relative movement in a first direction, and the limit disc is engaged with the outer gear so that the limit disc and the outer gear are limited to relative movement in a second direction, wherein the first direction, the second direction, and an axial direction of the limit disc are orthogonal to each other; and
a drive member coupled to the eccentric wheel, wherein the drive member has a rotation axis that is coaxial with the rotation axis of the eccentric wheel, wherein, when the drive member rotates, the brake block moves to the release position relative to the eccentric wheel so that the drive member drives the eccentric wheel and the brake block to rotate together, and when the drive member stops rotating, the elastic member pushes the brake block to the braking position to prevent the eccentric wheel and the brake block from rotating together.

2. The speed reducer according to claim 1, wherein:
one of the limit disc and the housing is provided with a first limit portion, and the other one of the limit disc and the housing is provided with a first limit groove, the first limit portion being fitted in the first limit groove and being movable in the first direction; and
one of the limit disc and the outer gear is provided with a second limit portion, and the other one of the limit disc and the outer gear is provided with a second limit groove, the second limit portion being fitted in the second limit groove and being movable in the second direction.

3. The speed reducer according to claim 2, wherein:
the first limit portion is on the housing, the second limit portion is on the outer gear, and the first limit groove and the second limit groove are in the limit disc; and
there are two first limit portions, two second limit portions, two first limit grooves, and two second limit grooves, wherein the two first limit portions are opposite in the first direction, and the two first limit grooves are opposite in the first direction, and wherein the two second limit portions are opposite in the second direction, and the two second limit grooves are opposite in the second direction.

4. The speed reducer according to claim 2, wherein the first limit portion and the second limit portion are cylindrical rods, and the first limit groove and the second limit groove are U-shaped grooves.

5. The speed reducer according to claim 1, wherein the eccentric wheel is provided with a toggle slot, the drive member is provided with a toggle block, and the toggle block is movably fitted in the toggle slot; and
wherein, when the drive member rotates in one of a clockwise direction or a counterclockwise direction, the toggle block overcomes an elastic force of the elastic member and pushes the brake block to the release position to drive the eccentric wheel and the brake block to rotate together.

6. The speed reducer according to claim 5, wherein, when the drive member rotates in the other one of the clockwise direction and the counterclockwise direction, the toggle block drives the eccentric wheel to rotate to make the brake block overcome the elastic force of the elastic member and move to the release position, so that the toggle block drives the eccentric wheel and the brake block to rotate together.

7. The speed reducer according to claim 5, wherein the housing has a first end and a second end, the second end of the housing is open and is covered by a cover plate, an end wall of the first end of the housing has an end wall hole, and the cover plate has a cover plate hole; and
one part of the inner gear is located in the housing and is rotatably supported by the housing, and the other part of the inner gear is located in the cover plate hole and is rotatably supported by the cover plate.

8. The speed reducer according to claim 7, wherein the drive member is a drive disc and comprises a disc body and a disc hub located at a center of the disc body; the toggle block is arranged on the disc body; and the disc hub is rotatably fitted in the end wall hole.

9. The speed reducer according to claim 7, wherein the inner gear has a central flange extending in the inner gear hole, the eccentric wheel has an eccentric wheel hole, the eccentric wheel is coaxial with the inner gear, and the central flange is rotatably fitted in the eccentric wheel hole.

10. The speed reducer according to claim 7, wherein an outer peripheral surface of the inner gear is a step surface to divide the inner gear into a large diameter part and a small diameter part, the small diameter part is rotatably fitted in the cover plate hole, and the large diameter part is rotatably fitted in the housing.

11. The speed reducer according to claim 1, wherein the eccentric wheel is provided with a first insertion hole and the brake block is provided with a second insertion hole; and
the elastic member is an arc-shaped spring, and the elastic member has a first end fitted in the first insertion hole and a second end fitted in the second insertion hole.

12. The speed reducer according to claim 1, wherein the eccentric wheel is provided with one of a guide rail and a guide groove; the brake block is provided with the other one of the guide rail and the guide groove; and the guide rail is slidably fitted in the guide groove.

13. The speed reducer according to claim 12, wherein the guide rail is arranged on the eccentric wheel; the guide rail and the guide groove are arc-shaped; and a curvature radius of an outer peripheral surface of the guide rail gradually increases along a direction from the release position to the braking position, or the outer peripheral surface of the guide rail forms a cam surface or a spiral surface gradually expanding radially outwards along a circumferential direction of the eccentric wheel.

14. The speed reducer according to claim 13, wherein a recess is formed at a junction of at least one end face of the eccentric wheel and an outer peripheral surface of the eccentric wheel, and the arc-shaped guide rail is arranged in the recess; a surface of the guide rail facing away from the brake block is flush with a surface of a rest part of the eccentric wheel facing away from the brake block; and a surface of the guide rail facing the brake block is recessed relative to a surface of the rest part of the eccentric wheel facing the brake block.

15. The speed reducer according to claim 14, wherein the brake block comprises an arc-shaped plate body, an arc-shaped outer boss, and an arc-shaped inner boss; the outer boss and the inner boss are arranged on the plate body and extend along a circumferential direction of the plate body; the outer boss and the inner boss are spaced apart from each other in a radial direction of the plate body; the arc-shaped guide groove is formed between the outer boss and the inner boss; an outer peripheral surface of the outer boss is flush with an outer peripheral surface of the plate body, and an inner peripheral surface of the inner boss is flush with an inner peripheral surface of the plate body; and
in the braking position, at least part of the outer peripheral surface of the outer boss and at least part of the outer peripheral surface of the plate body exceed the outer peripheral surface of the eccentric wheel in a radial direction of the eccentric wheel to abut against the outer gear; a first end of the outer boss and a first end of the inner boss are spaced apart from a first end of the plate body by a first distance, and a second end of the outer boss and a second end of the inner boss are spaced apart from a second end of the plate body by a second distance.

16. The speed reducer according to claim 1, wherein the eccentric wheel is provided with a first toggle slot and a second toggle slot; the drive member is provided with a first toggle block and a second toggle block; the first toggle block is movably fitted in the first toggle slot, and the second toggle block is movably fitted in the second toggle slot; and
the brake block corresponds to the first toggle slot; when the drive member rotates counterclockwise, the first toggle block overcomes an elastic force of the elastic member and pushes the brake block to the release position; and when the brake block moves to the release position, the second toggle block is spaced apart from or is in contact with an end wall surface of the second toggle slot.

17. A joint module, comprising:
the speed reducer according to claim 1; and
a motor, a motor shaft of the motor being coupled to a drive member of the speed reducer to drive the drive member to rotate.

18. A robotic arm, comprising the joint module according to claim 17.

19. A speed reducer, comprising:
a housing;
an inner gear rotatably coupled with and at least partially arranged in the housing, the inner gear having an inner gear hole, and a central axis of the inner gear hole being coaxial with a rotation axis of the inner gear;
an outer gear having an outer gear hole, the outer gear being at least partially arranged in the inner gear hole and interfaced with the inner gear to drive the inner gear to rotate, and the outer gear being translatable in a plane orthogonal to an axial direction of the outer gear and being prohibited from rotating around a central axis of the outer gear;
an eccentric wheel having an eccentric wheel hole, the eccentric wheel being rotatably and at least partially arranged in the outer gear hole to drive the outer gear to revolve around a central axis of the eccentric wheel hole, wherein a rotation axis of the eccentric wheel, the central axis of the eccentric wheel hole, and the central axis of the inner gear hole are coaxial, and a central axis of an outer peripheral surface of the eccentric wheel is eccentric relative to the central axis of the eccentric wheel hole;
a brake block arranged on the eccentric wheel to rotate together with the eccentric wheel, wherein the brake block is movable relative to the eccentric wheel between a braking position where the brake block abuts against the outer gear and a release position where the brake block is separated from the outer gear;
a spring coupled to the eccentric wheel and the brake block, and configured to press the brake block towards the braking position; and
a drive member coupled to the eccentric wheel, a rotation axis of the drive member being coaxial with the rotation axis of the eccentric wheel, wherein, when the drive member rotates, the brake block moves to the release position relative to the eccentric wheel so that the drive member drives the eccentric wheel and the brake block to rotate together, and when the drive member stops rotating, the spring pushes the brake block to the braking position to prevent the eccentric wheel and the brake block from rotating together.

20. A speed reducer, comprising:
a housing;
an inner gear rotatably coupled with and at least partially arranged in the housing, the inner gear having an inner gear hole;
an outer gear having an outer gear hole, the outer gear being at least partially arranged in the inner gear hole and interfaced with the inner gear;
an eccentric member rotatably arranged in the outer gear hole to drive the outer gear, a rotation axis of the eccentric member being coaxial with a central axis of the inner gear, a central axis of an outer peripheral surface of the eccentric member being eccentric relative to the rotation axis of the eccentric member, and the outer gear being revolvable around the rotation axis of the eccentric member and being prohibited from rotating around a central axis of the outer gear to drive the inner gear to rotate;
a brake member arranged on the eccentric member to rotate together with the eccentric member, the brake member being movable between a braking position and a release position relative to the eccentric member, wherein in a radial direction of the eccentric member, the brake member when in the braking position is further away from the rotation axis of the eccentric member than when in the release position; or
when the brake member moves from the release position towards the braking position, the brake member moves along a circumferential direction of the eccentric member and moves outwards along the radial direction of the eccentric member at the same time; or when the brake member moves from the release position towards the braking position, a motion trajectory of the brake member is a spiral or a cam contour gradually expanding radially outwards along the circumferential direction of the eccentric member;
an elastic member coupled to the eccentric member and the brake member, and configured to press the brake member towards the braking position; and
a rotatable drive member, a rotation axis of the drive member being coaxial with the rotation axis of the eccentric member, wherein, when the drive member rotates, the brake member moves to the release position relative to the eccentric member so that the drive member drives the eccentric member and the brake member to rotate together, and when the drive member stops rotating, the elastic member pushes the brake member to the braking position to prevent the eccentric member and the brake member from rotating together.
